(19) United States
(12) Patent Application Publication
(10) Pub. No.: US 2014/0082521 A1
(43) Pub. Date: Mar. 20, 2014

(54) EMAIL AND TASK MANAGEMENT SERVICES AND USER INTERFACE

(71) Applicant: Handle, Inc., San Francisco, CA (US)

(72) Inventors: Shawn CAROLAN, Los Altos, CA (US); Jonathan McCOY, San Francisco, CA (US); Ian G. McDOWELL, San Francisco, CA (US)

(73) Assignee: Handle, Inc., San Francisco, CA (US)

(21) Appl. No.: 14/030,918

(22) Filed: Sep. 18, 2013

Related U.S. Application Data
(60) Provisional application No. 61/703,705, filed on Sep. 20, 2012.
(60) Provisional application No. 61/816,625, filed on Apr. 26, 2013.

(51) Int. Cl. H04L 12/58

(52) U.S. Cl. CPC H04L 51/00
USPC 715/752

(57) ABSTRACT

A system, method, service, user interface, and computer readable medium to integrate email and task management is disclosed. Users are provided with options to convert an email into a task, including one-click command options. Efficient triaging of incoming emails is supported. Integration with different email systems and third party services is also supported. Additionally, context aware operation supports features such as adapting operation for efficient use of mobile device in combination with desktop computers.

### CROSS REFERENCE TO RELATED APPLICATIONS

This patent application claims the benefit of priority under 35 U.S.C. 119(e) to (i) U.S. Provisional Patent Application No. 61/703,705, filed on Sep. 20, 2012, entitled “EMAIL AND TASK MANAGEMENT SERVICES AND USER INTERFACE”, and (ii) U.S. Provisional Patent Application No. 61/816,625 filed on Apr. 26, 2013, entitled “EMAIL AND TASK MANAGEMENT SERVICES AND USER INTERFACE,” each of which are incorporated by reference in their entirety for all purposes.

### BACKGROUND OF THE INVENTION

Processing email and tasks using conventional software approaches occupies a substantial amount of time for knowledge workers. Knowledge workers typically receive numerous email messages each day that they need to process. Additionally, knowledge workers often create tasks for various projects. However, conventional email and task management software is inefficient and does not provide an efficient workflow for knowledge workers to get things done in terms of processing emails and tasks efficiently to generate value.

Therefore, what is desired is improved email and task management services and user interfaces to better use the time of knowledge workers and to increase productivity in organizations.

### SUMMARY OF THE INVENTION

An apparatus, method, system, service, user interface and computer program product is disclosed for integrating email and task management. An email may be converted into a task. In one embodiment a user is provided with a consolidated view of both incoming emails and tasks. A command map having single click commands for handling emails and tasks supports efficient processing of emails and tasks.

In one implementation, incoming emails are processed by a user in a scan mode, triage mode, plan mode, do mode and a capture mode. In one embodiment a handlebar is a user interface that supports efficient management of emails and tasks. Integration with third party email and service providers is supported. Context aware implementations and optimizations in mobile devices is also supported.

### BRIEF DESCRIPTION OF THE DRAWINGS

FIG. 1 shows a list view mode of Handle in accordance with an embodiment of the present invention and FIG. 1A is a detailed view of a navigation panel.

FIGS. 2A-2C illustrate task views and FIG. 2D illustrates a project view in accordance with an embodiment of the present invention.

FIG. 3A illustrates a focus mode illustrating an individual email, the Handlebar user interface, and a view of new emails and tasks.

FIG. 3B illustrates exemplary commands.

FIG. 4 is a process flow chart illustrating how emails may be processed in accordance with an embodiment of the present invention.

FIG. 5 illustrates a high-level system view of a service providing Handle in accordance with an embodiment of the present invention.

FIG. 6 illustrates a cloud assist to support transferring extended metadata beyond that of conventional email protocols in accordance with an embodiment of the present invention.

FIG. 7 illustrates an implementation of Handle having support for common user interface commands with third party services in accordance with an embodiment of the present invention.

FIG. 8 illustrates an implementation of Handle having support for natural language processing and access of third party services in accordance with an embodiment of the present invention.

FIG. 9 illustrates a collaboration container that permits native interaction from messages in the container in accordance with an embodiment of the present invention.

FIGS. 10A and 10B illustrate applications of a VIP list in accordance with an embodiment of the present invention.

FIG. 11 shows an inline dropdown menu for a set of basic commands in accordance with an embodiment of the present invention.

FIG. 12 shows the handlebar after an archive command has been entered in accordance with an embodiment of the present invention.

FIG. 13A shows the handlebar after a label command has been entered, with additional inline guidance provided on potential label options in accordance with an embodiment of the present invention.

FIGS. 13B and 13C show aspects of entry of additional metadata for the labeling command in accordance with an embodiment of the present invention.

FIG. 14A illustrates an example of the handlebar after a task command has been entered for an email in accordance with an embodiment of the present invention.

FIG. 14B illustrates an additional bubble with inline guidance for entering metadata for the task, such as project metadata, importance metadata, deadline metadata, and snooze metadata.

FIG. 14C illustrates entering a deadline for a task.

FIG. 14D illustrates how additional bubbles may open up to enter optional metadata for a task in accordance with one embodiment of the present invention.

FIG. 15A illustrates the entry of a handoff command and a default entry of the title of the email as the title of the handoff.

FIG. 15B illustrates confirmation of a proposed handoff title in accordance with one embodiment of the present invention.

FIG. 15C illustrates that a recipient field added to the handoff along with an optional note in accordance with one embodiment of the present invention.

FIG. 16 illustrates a bubble in the handlebar showing a read later command was entered in accordance with one embodiment of the present invention.

FIG. 17 illustrates a bubble in the handlebar showing an unsubscribe command was entered in accordance with one embodiment of the present invention.

FIG. 18 illustrates a bubble in the handlebar showing a delete command was entered in accordance with one embodiment of the present invention.

FIG. 19 illustrates a bubble in the handlebar showing a compose command was entered in accordance with one embodiment of the present invention.

FIGS. 20-27 illustrate aspects of a deliverables paradigm in accordance with one embodiment of the present invention.

FIG. 28 illustrates a methodology for processing messages, tasks, and information using a multi-phase approach in accordance with an embodiment of the present invention.

FIGS. 29-33 illustrate aspects of the methodology of FIG. 28 in selected embodiments of the present invention.

FIGS. 34A and 34B illustrate aspects of a triage plan in accordance with an embodiment of the present invention.

FIGS. 35-40 illustrate aspects related to assigning priority levels and other metadata in accordance with embodiments of the present invention.

FIG. 41 illustrates a today listing in accordance with one embodiment of the present invention.

FIG. 42 illustrates a smiley face game in accordance with an embodiment of the present invention.

FIG. 43 illustrates a publishing mode in accordance with an embodiment of the present invention.

FIG. 44 illustrates an embodiment of Handle Habit supporting context in accordance with an embodiment of the present invention.

FIG. 45 illustrates additional aspects for supporting context in accordance with an embodiment of the present invention.

FIGS. 46-48 are screenshots illustrating triage options on a mobile device in accordance with an embodiment of the present invention.

### DETAILED DESCRIPTION

### General Description and High Level Overview of Handle

Embodiments of the present invention are directed to a fully integrated email client and task management application. A version of this application is named “Handle,” and in one embodiment, includes a unified navigation view of emails and tasks, a common toolbar for entering commands for emails and task, and includes other features and functions.

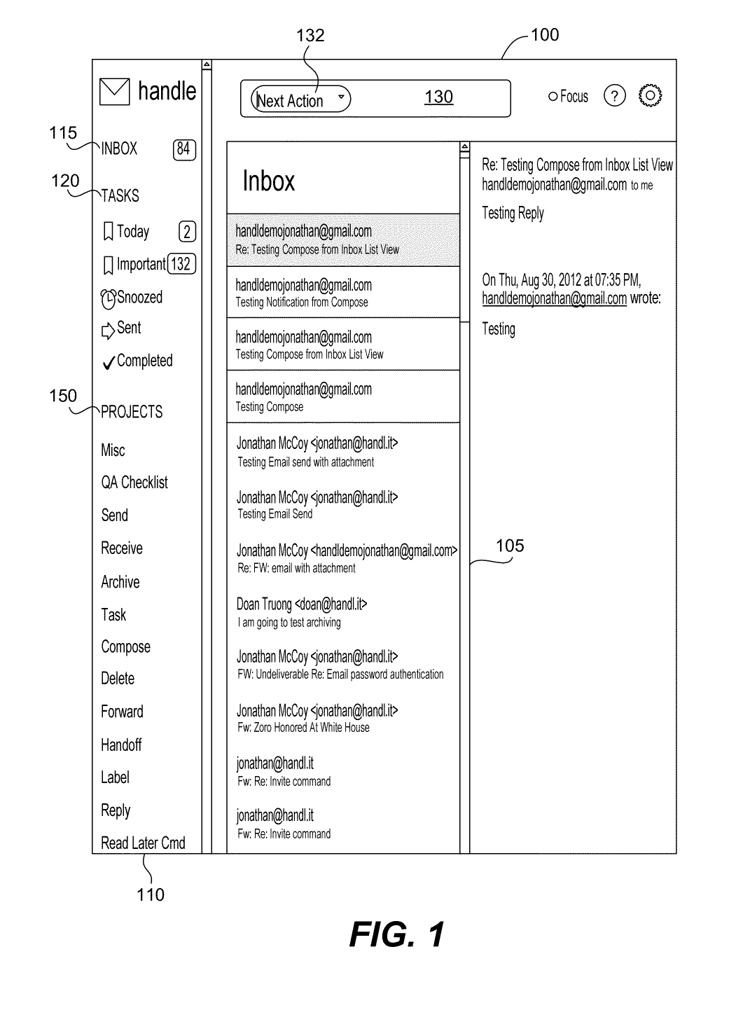

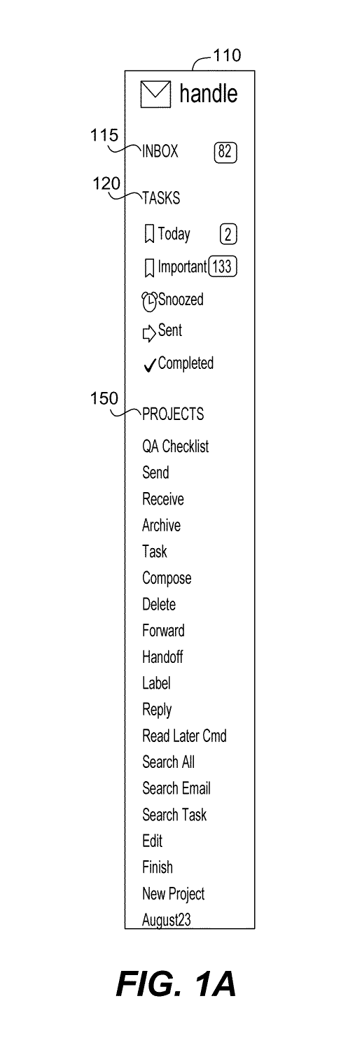

Referring to FIG. 1, a portion of an illustrative user interface 100 is shown in a list mode, showing a list view 105 of incoming emails in an inbox. In this example, the user is beginning with 84 emails in their inbox. A navigation panel 110 (detailed view in FIG. 1A) includes a consolidated view of both an email inbox 115, and also a task view box 120 listing a task count of tasks (as an illustrative example there may be two tasks due today and 132 important tasks). The tasks may be further categorized and listed by one or more factors, such as whether the tasks are important, and whether the tasks are due today. In one implementation, task priority includes high priority, medium priority, and maybe. In one embodiment, snoozing of tasks is provided in which tasks are hidden from view during a snooze period, and then re-appear in their normal place upon expiration of the snooze period. The navigation panel may also list projects 150 (to permit the user to dig deeper into tasks associated with projects and/or other information on emails that have been initially processed to remove them from display in the inbox). Additionally, the navigation panel may include a list of emails converted into media (not shown in FIG. 1). Thus, the user is provided navigation information to navigate back and forth between incoming emails, tasks, and also, other forms of information such as projects.

In one embodiment, a user interface feature for quickly processing information is user interface element currently known as a “handlebar.” The handlebar 130 may appear as a bar-shaped toolbar element towards the top of the screen and include a command line field bubble to enter a command, in-line drop-down menus, or other features to enter commands. Additionally, as will be discussed later, the handlebar may also command display bubbles showing a command that was entered, and may also provide visual confirmation of mandatory and optional metadata entered for a command. It will be understood that a toolbar implementation is only one design choice and the exact shape, size, and location of the handlebar on the user interface may vary from that illustrated in the accompanying figures.

The handlebar 130 is a user interface element that includes a field to enter commands and field to enter associated metadata. The handlebar may appear in an email list mode, in a focus mode, or in other modes of operations. In one embodiment, a next action bubble 132 appears for a user to indicate a desired action to be performed. Exemplary actions commands in a command map include archive, compose, delete, edit, forward, handoff, label, later, move to, reply, search, task, and unsubscribe. In one embodiment, a user may enter commands for a character, or alternatively, the user may view an in-line menu below the next action bubble. Each command preferably has an associated 1-click command. For example, a 1-click command may be based on the first letter of the command, such as “a” for archive, “c” for compose, etc.

In one embodiment, a metadata map includes an interaction model to guide a user through a sequence of 1 click commands. If no additional metadata is required on the command, the command will complete, such as hitting an ‘a’ to archive in a single keystroke. Additional required fields then pop into the handlebar, in a sequence that guides the user to input the correct sequence of required and optional metadata. An individual key (e.g., the shift key) may be designated to bring up metadata options. Examples of additional metadata commands include at (for a place), due on (to set a deadline), estimate (to create an estimate of a time expected to complete a task), importance, note (to populate a note field with text), project (to set the project or deliverable name), snooze until (to set a snooze date), to (to hand off a task to another person), urgent (to put a task at the front of the important queue), and with (to denote a person).

In one embodiment, emails may be handled in a list mode and also in a focus mode. A focus button or other feature or command is provided to switch to the focus mode.

High-level tracking features are preferably provided to give the user a view of the number of unread emails in the inbox and also the number of tasks. This information is preferably provided to the user on the same page that the user is entering other commands or metadata to the handlebar. This same page notification provides contextual information to aid a user in quickly and efficiently processing emails. Other forms of feedback may also be provided to indicate to a user that a command has been successfully entered, and to aid a user to keep track of where there are in regards to processing incoming emails and tasks.

A command may be executed upon receipt if all necessary and optional metadata has been entered. Additionally, a character, such as a carriage return, may be assigned in some situation to indicate completion of entry of metadata in order to trigger execution of a command.

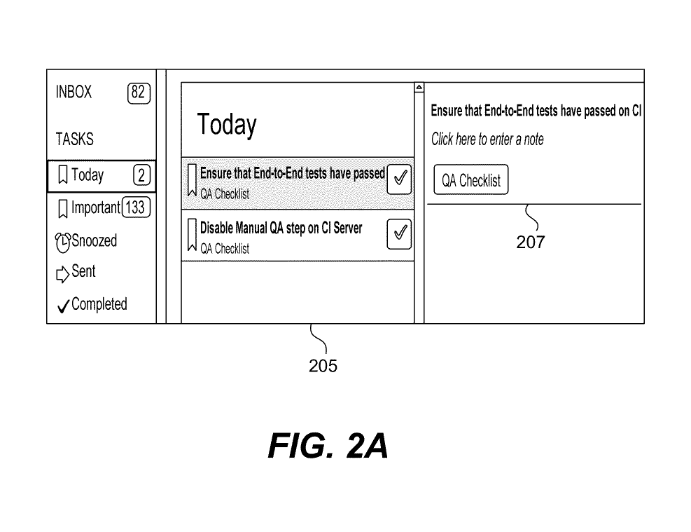

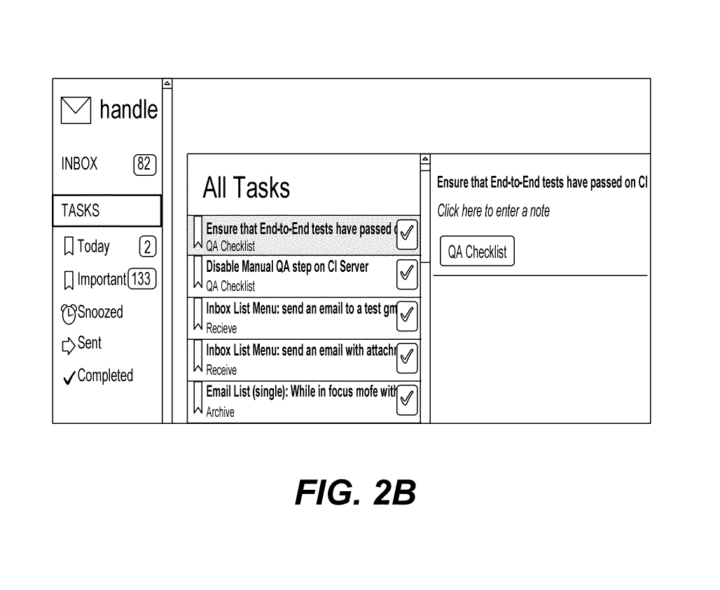

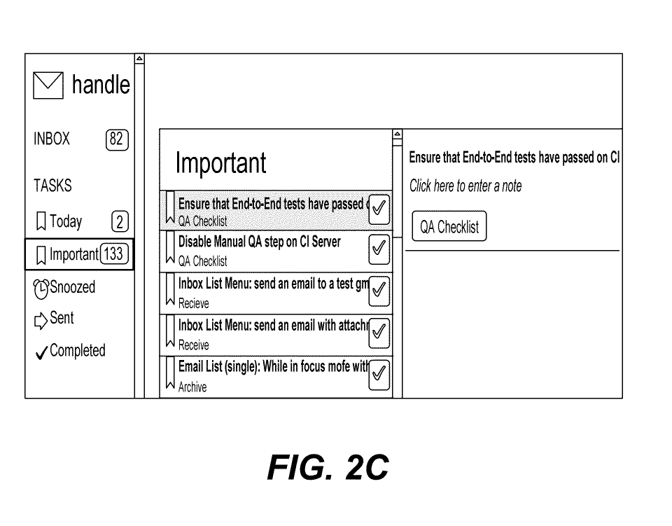

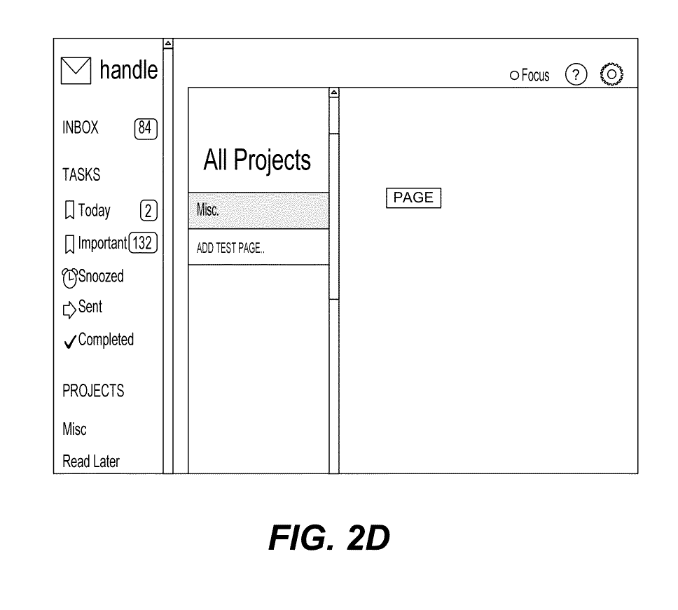

The tasks may be viewed in different ways to aid a user to navigate tasks. FIG. 2A illustrates a portion of an illustrative user interface in a task mode, showing the current day's tasks in a task list view 205. For example, if there are two tasks due today then the task list view shows the two tasks. Each task in the listing includes a task title and an expanded view of selected task may be provided. FIG. 2B illustrates an all task view, showing a list of all tasks. FIG. 2C shows a view of tasks designated as important or otherwise having a high priority. Similarly, FIG. 2D illustrates a project view, showing all projects and an example of a read later folder. In this example, the project view is an “all projects” view. More generally, individual aspects of projects may be displayed in different types of project views.

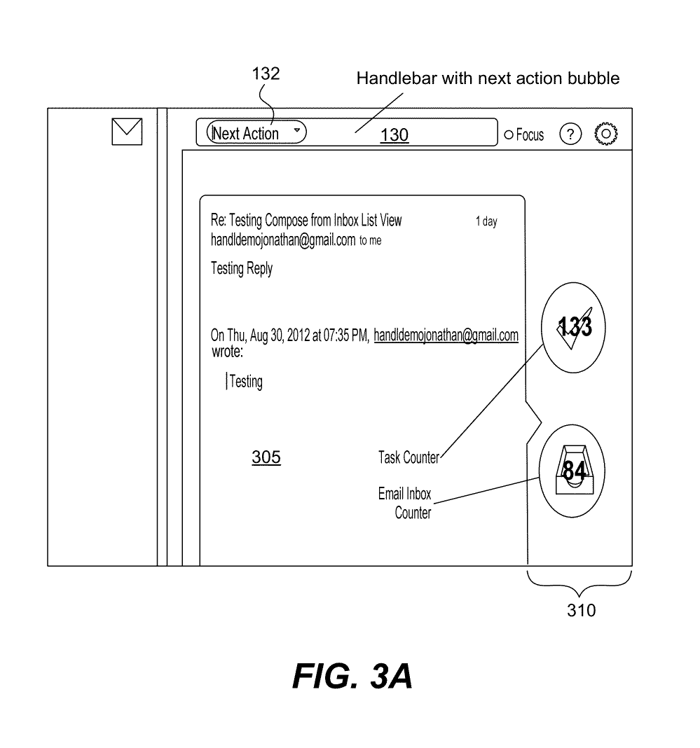

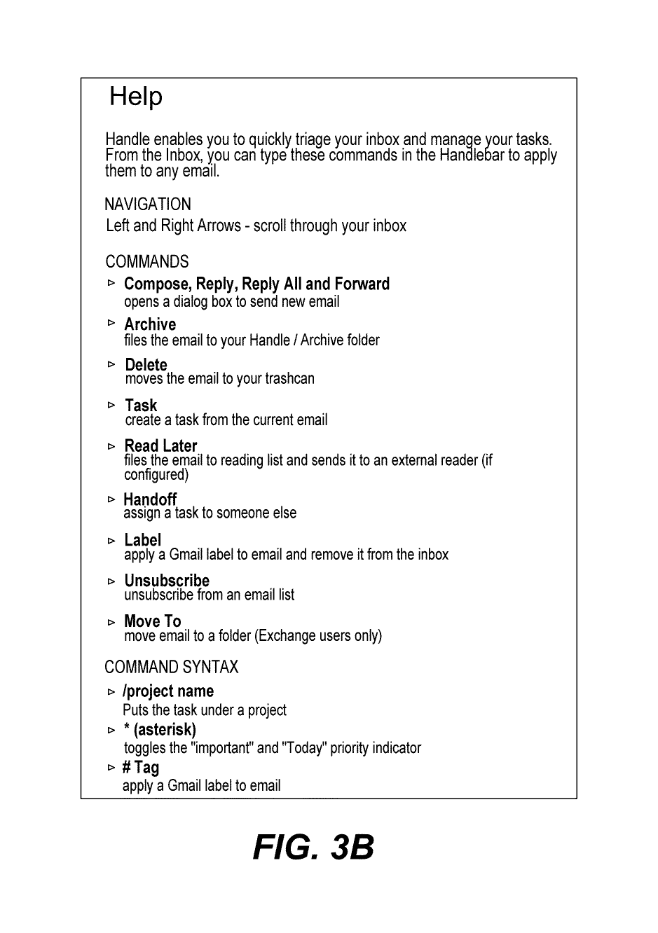

FIG. 3A illustrates a portion of an illustrative user interface showing the handlebar 130 in the focus mode. FIG. 3B shows an illustrative partial list of commands. In the focus mode one email at a time is displayed 305 along with the handlebar 130. A next action bubble 132 is displayed in the handlebar 130 for a user to enter a command to process the email. On the right-hand portion of the user interface contextual information 310 on the number of emails in the inbox and the number of tasks may also be provided. In this example, an image of the total number of total inbox count and task count is presented in the focus mode. More generally, any form of contextual information may be provided to aid a user in the focus mode to provide context. Additional forms of visual confirmation provide visual feedback that acts as high-level tracking to aid a user understand when emails are successfully processed into tasks and/or provide confirmation regarding any other processing operation performed on an email. Such visual confirmation aids a user to understand that an email has been successfully processed in the manner intended by the user without requiring the user to exit from the focus mode.

In one embodiment, commands available in the handlebar may be context sensitive based on location (e.g., browser vs. email) and the content of the message (e.g., a LinkedIn invite vs. email from a friend).

In one embodiment, a media command is included for emails containing video or other media, such as audio links or clips. That is, a specific command is provided to take an email having media (or links to media) and assign the email as media in a media file. Thus, with a single command a user can convert an incoming email into a media object stored in a media file.

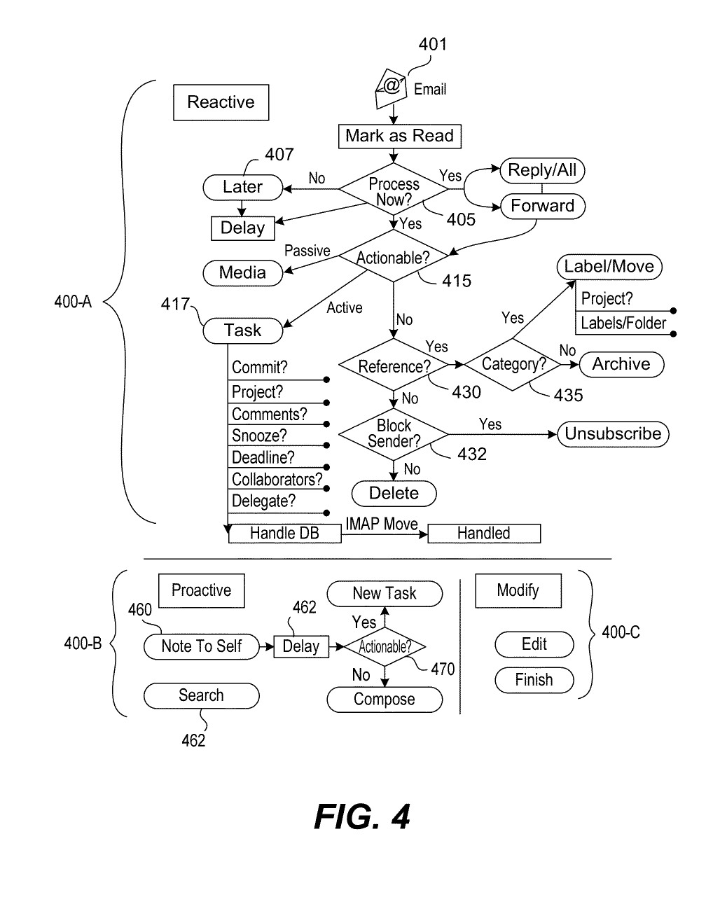

FIG. 4 illustrates an exemplary process flow for processing an incoming email 401. In a reactive mode 400-A, if the user decides to immediately respond, they may reply to the email or forward the email, as in conventional email systems. However, they may also use Handle to process the email in new ways.

A decision may be made whether an email is important enough to process now 405. If the email is of lesser importance, it may be processed later 407 and then turned into a task. The later option 407 effectively creates a second inbox of emails that the user chooses to process later. Emails that are processed may be actionable emails 415, which include passive emails (e.g., emails including media to be played) or active emails, which may be converted into a task 417. Other options for a task include adding a note, performing a snooze, asking for commitment, associating the task with a project, adding a deadline, delegating the task, and associating the task with collaborators.

Emails that are not actionable may be checked to determine if there is a reference 430 for the email. If there is no reference, a decision may be made to block the sender 432 and/or unsubscribe from an email subscription (using either an automated feature or by delegating the unsubscribe to another party). If there is a reference for the email, a decision may be made whether to categorize 435 the email by labeling/moving it to a project or a labels folder. Alternatively, if there is no applicable category, the email may be archived. In one embodiment, an email having video may be converted into a media object.

In a proactive mode 400-B, the user may, for example, add notes to self 460, delay emails 462, and then at a later date convert actionable emails 470 into new tasks or compose new emails. A search feature 462 is also preferably supported. A modify mode 400-C includes features such as an edit feature and a finish feature.

In one embodiment, support is provided to seamlessly integrate the handlebar with different email services. APIs may be provided to allow third parties to make their own commands that seamlessly integrated into the handlebar with auto-fill for their field. Additionally, support may be provided for third party APIs, such as contextual e-commerce services, using the content of an email and user information previously stored, to permit the handlebar to be integrated with other services besides email and task management.

One aspect of the integrated email client and task management is that metadata dimensions are abstracted on top of an email or other unstructured data payload. As an example, an email may be converted into a task and have additional metadata abstracted onto the email, such as a task name, priority, deadline, or project. Additionally, tags and persons may be associated with an email. Notes may also be associated with an email. Tags are directed to different features of an email application As a result embodiments of the present invention are also relevant to processing emails and tasks associated with projects.

In another embodiment, a “deliverable” is a construct that combines subtasks, personal notes, and associated them with collaborators and stakeholders into a single view with a constrained verb set of commands to be an update of a document in a repository of the organization.

These and other aspects of the Handle email and task management application and support services are described below in more detail and in the accompanying drawings and appendices.

### I. System Level Architecture, Cloud Assisted Communications, and Integration of Third Party Applications

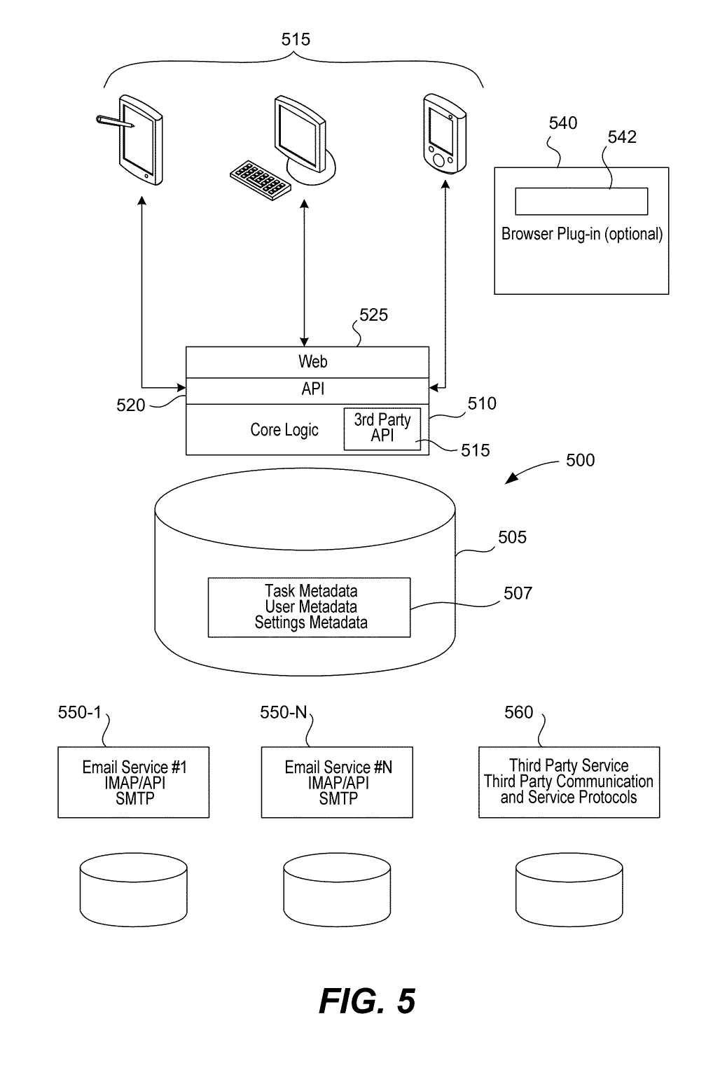

FIG. 5 is a high level diagram of a system 500 providing a service for email and task management in accordance with one embodiment of the present invention. The system 500 includes hardware components, such as one or more servers and associated memories and processors. The system includes a database 505 to store metadata 507, such as collaboration metadata, task metadata, and project metadata; user metadata, and other settings metadata. The database 505 or any other suitable storage unit may also store the computer program code to implement any of the methods described in this patent application and generate user interfaces that are displayed on client devices 515, such as computers and mobile devices.

Core logic 510 includes support for third party APIs 515, such as APIs to communicate with different email service providers such as Google's Gmail and Microsoft's Exchange. For each third party email service 550 supported, there is corresponding support for the protocols and proprietary features that are used (e.g., IMAP and Exchange Web Services (EWS) for Microsoft Exchange). More generally, the support for third party APIs may includes support for third party text, voice, and social media applications 560, such as Facebook®, Linked-In®, and Twitter®.

Additionally, support may be provided for other third party services, such as ecommerce services. This may include token support and translation of third party API commands.

Web support 525 is provided for web-connected devices. In one embodiment, the system communicates with a user's web browser via JAVA script to generate a user interface on the user's device and receive back user inputs. API support 520 is provided to support communication and operation with wireless devices such as tablets and smart phones. In an alternate embodiment, the service is provided as a browser plug-in 540 that provides a context aware toolbar 542.

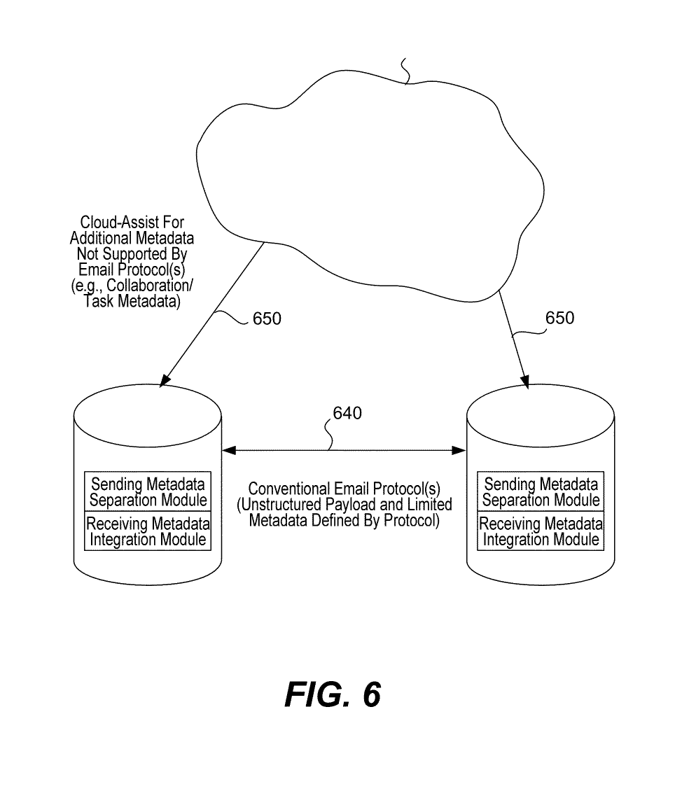

FIG. 6 illustrates a method of using a cloud computing 605 assist to support transferring messages (e.g., email, voicemail, text, etc) with an extended set of metadata not supported by conventional email protocols. For the purposes of illustration, that portion of the email that can be sent using conventional protocols in sent and received using the conventional email protocol, as illustrated by arrow 640. The extended metadata is separately sent via the cloud assist and then reintegrated with the conventional email component upon receipt as indicated by arrows 650.

Examples of extended metadata include task management metadata, project metadata, and collaboration metadata, in accordance with one embodiment of the present invention. The cloud assist is used to support the transfer of extended metadata. As illustrative examples, the extended metadata may include metadata for task functions such as “deadline,” “snooze,” “task project,” and “importance.” Other examples include adding an optional note when a task is handed off. Other types of collaboration metadata, task metadata, or collaboration metadata may also be transferred. The cloud assist may be implemented by pointing to the cloud with a browser. However, in an alternate embodiment a client based implementation may be used.

In contrast, conventional email protocols such as Internet Messaging Access Protocol (IMAP), Simple Mail Transfer Protocol (SMTP), or the Post Office Protocol (POP) are designed to communicate a message payload and a limited set of metadata defined by the mail protocol. Similarly, other Internet messaging protocols also communicate only a limited set of metadata defined by the communication protocol. For example, conventional communication protocols, such as IMAP, have no support for task oriented metadata, project oriented metadata, or task/project team collaboration metadata.

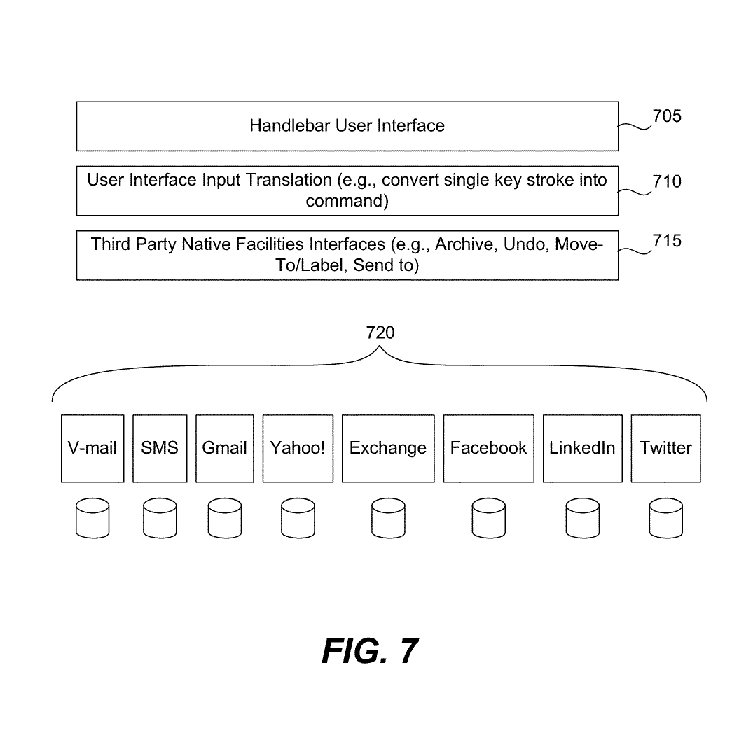

FIG. 7 illustrates additional aspects of the core logic 510 related to the use of the third party mail and messaging services. At a logical level, a logical layer 705 is provided to support the Handlebar user interface and its associated workflow. A user interface input translation layer 710 implements a command map, such as to convert a single keystroke into a command. Below that, a third party facilities interface layer 715 is provided to interface between third party services 720, such as third party voicemail (V-mail), messaging (SMS), email (Gmail® Yahoo! ® Exchange® and social media services (e.g., Facebook®, LinkedIn®, and Twitter®. As one example, the third party native facilities interface can adapt a command entered in the user interface to be compatible with variations in how commands are common to many different services. For example, the archive command is implemented differently in Gmail and Exchange. A user may input a single command into the handlebar, such as “a” for archive, and then the logic will automatically perform any necessary conversion of the command into the protocol of the third party service. As a result, a user can learn one set of commands and have a particular command (such as archive, undo, move-to, and send to) implemented the same on any of the third party services, regardless of variations in how the command is implemented by different third party services.

As another example, different email systems having different views of email threads of related messages in an email string. Gmail has a different thread view policy than Exchange. In one embodiment, a common view of threading is provided by the third party native facilities interfaces, regardless of the third party email service that is used. This creates a universal view of threading.

In one embodiment, a common threaded view of email opens up with a task and all new email in the thread is associated with a task. Additionally, in one embodiment a new email that is composed starting from a task is associated with the task.

More generally, universal views of other types of third party services may also be generated from third party services providing similar types of services. For example, universal views of voicemail, messaging, social media updates, ecommerce, or other third party services may be provided.

### II. Navigation and Invocation of Third Party Web Services

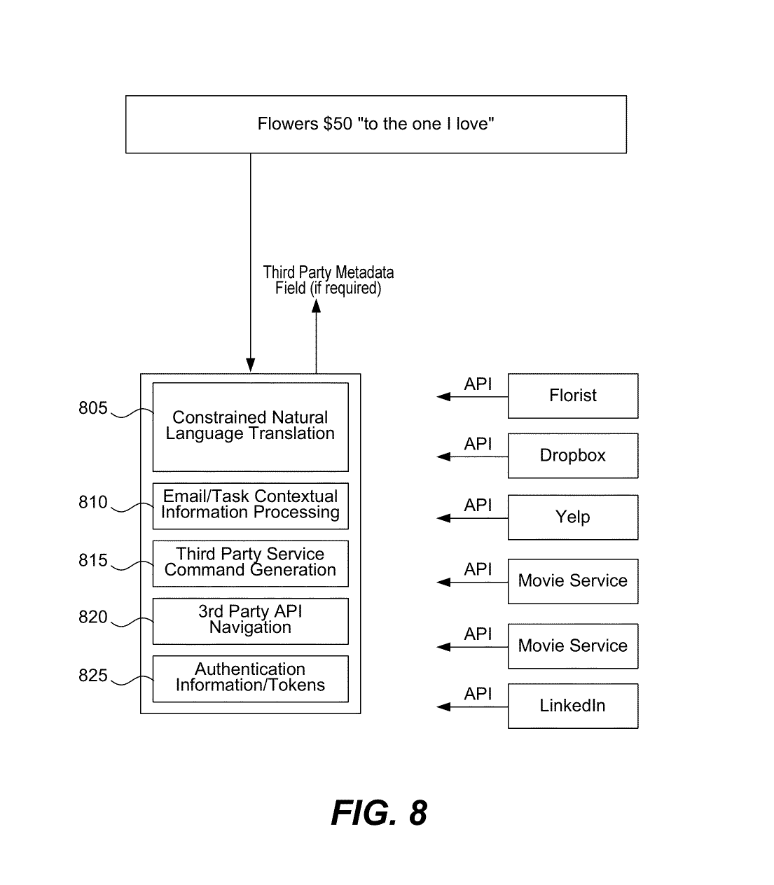

FIG. 8 illustrates an embodiment of command line implication of web services via the handlebar. Authentication information is stored for the user for a set of web services. Additionally, the corresponding API navigation information is also pre-stored.

The command line field of the handlebar can thus be used to invoke third part web services, such as APIs to Dropbox®, LinkedIn®, Yelp®, entertainment services, and e-commerce services. In one embodiment, an “if this, then that” (IFTTT) set of rules is correlated to accounts via a nexus of authenticated services. For example in token-based authentication the proper token for an authenticated service is accessed 825.

The command line input to implicate a web service may include a set of fixed verb commands such as “buy.” However, to support greater flexibility and ease of use, in one embodiment, constrained natural language processing 805 is performed to permit the user to enter a natural language command into the handlebar. The natural language translation is constrained in the sense that there are limited choices that provide contextual meaning. Additionally, contextual information 810 may be derived from the set of third party services that the user has been authenticated to. Thus, “Flowers $50 ‘to the one I love’” has a potential association between flowers and love with the third party service of Florist (a source of flowers). Third party metadata fields may be returned in response to the command line input, such as metadata fields for a price, number, or message for a flower order.

Additionally, in one embodiment, contextual information is derived from what the user is viewing when the command is entered into the handlebar. For example, if the user is viewing an email, contextual information may be derived from the email, such as the name of the sender of the email. Similarly, if the user is viewing a task, contextual information may be derived from the task.

A portion of core logic determines 815 the desired service and invokes the corresponding API calls to implement the command. As an illustrative example, a user may input a natural language command, such as “buy” followed by further natural language inputs that are interpreted as metadata. Additionally, contextual information may be obtained from the content of an email, such as the sender's name or other information in the subject line or the body of the email. For example, a command such as “Flowers $50 ‘to the one I Love’” in the context of received email from a loved one may be interpreted to generate a command to order flowers for the person associated with the email.

In one embodiment, APIs 820 are provided to allow third parties to make their own commands that can be seamlessly integrated into the handlebar with auto-fill for specific fields. In this embodiment the handlebar provides an abstracted view of third party services in which there is auto-fill support for the commands of a third party service and support for specific commands of the third party service.

### III. Collaboration Container Embedding Mail Functionality

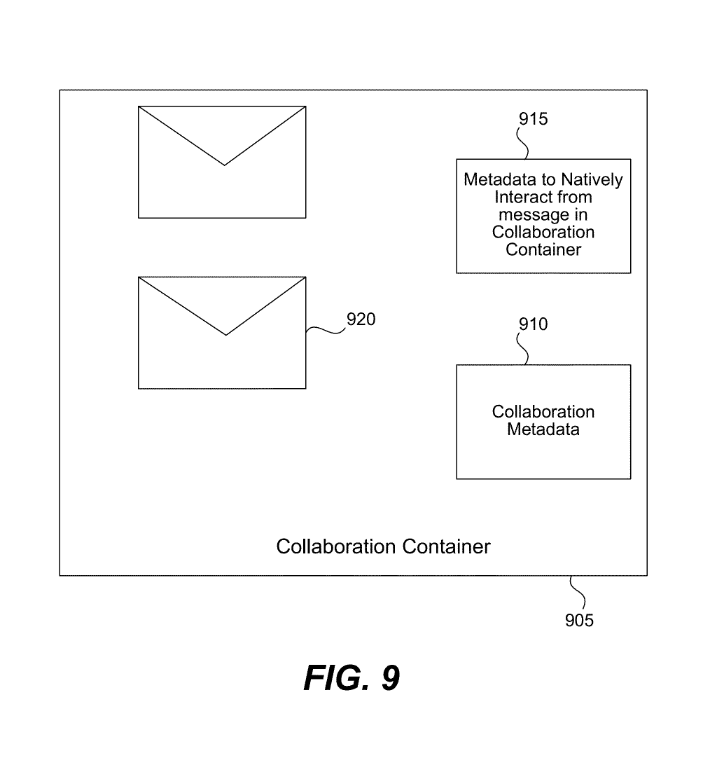

FIG. 9 illustrates a persistent collaboration container 905 in accordance with one embodiment of the present invention. The collaboration container has a user interface representation and is supported by collaboration metadata 910 stored in the database. In one embodiment, an email (or voicemail) message is converted into a persistent collaboration container. As illustrative examples, the collaboration container can be a task generated from an email or a calendar item generated from an email.

The collaboration container includes the contents 920 of the original mail item along with metadata 915 to permit a direct native interaction from the collaboration container, such as responding to an email or directly calling from a voicemail in the container. For example, for email this may include maintain the MIME information of the original mail within the container such that a user can use a single click to respond from within the container to respond to follow-up. However, additionally, the collaboration container includes additional collaboration metadata. As one example, the collaboration container may be for a specific task (e.g., a task container) and have task metadata. As another example, the collaboration container may for a calendar item and including additional metadata associated with the calendar item. Additionally, in one embodiment additional files or other information may be associated with the collaboration container.

The use of collaboration containers permits, for example, inbound emails to be converted into an object having a higher level of abstraction related to workflow, form associations of other information in the collaboration container, and permit direct, native interaction from within the container, such as directly responding to the sender of a voicemail or email that is contained within the container.

As one example, in a task container, shared comments may be sent from the task container.

### IV. VIP List and Associating New Inbound Message on Existing Entities

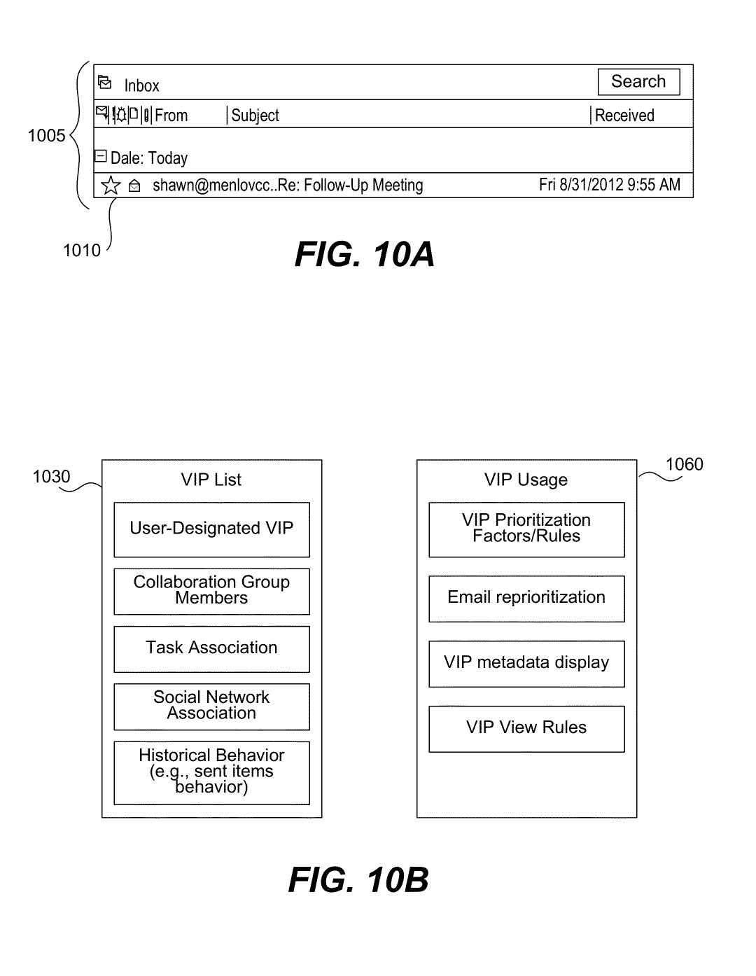

In one embodiment, a VIP list is generated for inbound emails. As illustrated in FIG. 10A, the user interface 1005 may display a special symbol 1010, such as a star, to indicate that an inbound email is from a VIP. Referring to FIG. 10B (bottom), a VIP list 1030 may be generated in a variety of different ways. In one embodiment, a user may designate individuals that are on the VIP list. Additionally, the VIP list may be populated based on an association with tasks, projects, and collaboration groups. For example, when a task is formed from an email, it inherently has individuals associated with the tasks from the original email metadata; additionally, other individuals can be associated with the task as part of a collaboration group. A VIP list may also be populated based on historical behavior of the user, such as from the user's sent email list. Additionally, social network information may be used to populate a VIP list, such as by including individuals in the VIP list that are members of social media groups that the user belongs to.

A multi-factor analysis can be performed to determine individuals on a VIP list and their ranking compared to each other. This multi-factor analysis can for example, be based on factors such as the time deadline of a task, the urgency and importance of a task, historical analysis of the user's choices in handling email, etc.

The VIP list information may be used 1060 in a variety of different ways, as illustrated in the right panel of FIG. 10B. One application of a VIP list is to prioritize incoming email based on the VIP list. For example, inbound emails associated with contacts on the VIP lists may be displayed first in the display listing of new inbound emails. If the VIP list includes an additional ranking (e.g., VIPs and extremely important VIPs), the emails may be further prioritized based on the sub-category of VIP.

Another application of the VIP list is to automatically correlate the collaboration/task priority based on the VIP contact list. In one embodiment, if a VIP is associated with an existing task, the task priority may be adjusted based on the fact that the original email is from a VIP.

In one embodiment, the VIP lists the VIP function results in automatic metadata labeling of inbound emails using thread IDs, semantic IDs, semantic analysis, and sender email address to automatically label inbound emails with metadata to streamline the user data inputs that are required. In particular, associations may be made based on the fact that an email is from a VIP or otherwise related to the VIP directly or indirectly. These associations may also be used as a factor in determining how to process or display an email.

As additional examples, rules may also be applied for determining when to display messages from VIPs and when to display the VIP metadata symbol. For example, in one embodiment a VIP view rule has a mode that permits the display of new message notifications and/or display of email text only from VIPs. More generally, the VIP view rule may be used to select how emails from VIPs are displayed differently than from other users. This permits, for example, modes of operation in which the user is not distracted by email from non-VIPs.

### V. Focus Mode

A. Exemplary Command Map and Metadata Map

In one embodiment the focus mode has shortcut key strokes (e.g., 1-2 keystrokes) to process email, such as turning email into a task or project. Additionally, in one embodiment metadata choices are navigated by limited choice and inline guidance is provided to aid a user navigate deep metadata choices with a minimal number of keystrokes.

An exemplary command map, illustrating commands and corresponding single-character (1-click command) implementations underlined, is as follows:
Interaction model
   Every letter has a default, if you hit the lower case letter, the default gets entered with a single keystroke
   Hit the shift key or click on arrow to see full list of commands. Hitting Shift-X will bring up auto-suggest with all of the X commands if there are 3 or more, if there are only two Shift-X will invoke the second one.
archive (to archive an email)
compose (to compose a new email)
delete (to delete an emails)
edit
forward (to forward an email)
handoff (to handoff a task)
label (to add a label to an email)
Later
move to
Media (vs. Read Later in order to accommodate video or other media)
reply
search
task
Task (creates a new task not associated with current email)
unsubscribe

A variety of metadata may be associated with some commands. In one embodiment the metadata map includes an interaction model as follows:
If no metadata is required on the command, it will complete immediately. For example, hitting ‘a’ will archive in a single keystroke.
All required field preferably pop into the Handlebar immediately.
After required fields are complete, if additional optional metadata exists, a bubble with ghost text “description?” invites further entry.
Shift key brings up all metadata options.
When the user hits a letter to enter more metadata, a bubble springs up with the glyph and words and a field to start typing, for example “<glyph> due on”. When data entry is complete, glyph remains but words collapse.

Examples of additional metadata that may be added include:
at—denotes a place, ‘home’, ‘work’, ‘school’ will be personalized versions, but ‘the grocery store’ or ‘the hardware store’ could be more generic containers for types of places.
due on—set a deadline
estimate—how many minutes it is expected to take to complete
important—denotes the task is important, adds to the end of important queue
note—populates the notes field with additional text
project—set the project/deliverable name
snooze until—sets a snooze date
to—hands off task to another person
urgent—puts at the front of the important queue
with—denotes a person
‘.’ (period) ends the current ‘sentence’ and starts another for the same email.

B. Personalized Command Map

In one embodiment, additional personalization of the command map is supported, which may also include support for third party APIs. An individual user can have a personalized command map of choices based on their role and how they fit in it. In one embodiment, the personalization in focus mode includes varying the verb set of the commands based on the message type or the person.

In one implementation, the personalized commands are based on the message type, the message content, and from context generated commands. For example, a message type corresponding to an email sent via an intermediate service such as LinkedIn may open up the LinkedIn profile of the sender. In this example, the context window fills the screen and accepts the new link. As another example for email with a video file, the personalized command may be to automatically open the video.

As another example of a personalized command, in one embodiment if a user receives an email including links to photos or videos, a personalized command is supported to load the photos or videos to a third party service, such as Shutterfly®.

As another example of personalization, in one embodiment a subset of metadata choices and follow-on commands is provided for a particular command. As one example, in one implementation, a selection is made of a smaller set of commands for a personalized command for handoff, full set vs. smaller set. The personalization may, for example, be made by the user, suggested based on historical usage, or selected based on other factors, such as other contextual information regarding the task.

C. Prioritization of Workflow in Focus Mode

In one embodiment, the focus mode uses metadata to prioritize the workflow for task management. One option is a chronological order. Another option is for the user to set the priority according to one or more factors. As example, the priority may be set using project priority, a person priority, temporal priority, historical behavior of the user from sent items, cross modal priority, such as whether there are additional voicemail messages. A weighted function can be used. Additional, individual factors can be inferred.

Additionally, in the focus mode there can also be an automatic order/priority that is set according to one or more rules.

D. Deep Metadata Navigation Through Constrained UI and Inline Guidance

In one embodiment, the handlebar implicitly has required fields and optional fields. Examples of commands include task, archive, move to, Dropbox®, and Evernote®. Inline guidance is also provided for each field, showing a listing of possible entries for that field. Additionally, after a field is filed in, if additional metadata is required then another field opens up in a bubble to permit entry of the next set of metadata. This additional field also has inline guidance. This process may be continued until all of the different types of mandatory and optional metadata are filled in. In one embodiment the user may enter optional metadata in any order, filling out one bubble and then another. A command, such as a carriage return, may be entered by the user after all required metadata has been entered in order to complete the command.

E. Additional Examples of Handle Use Modes

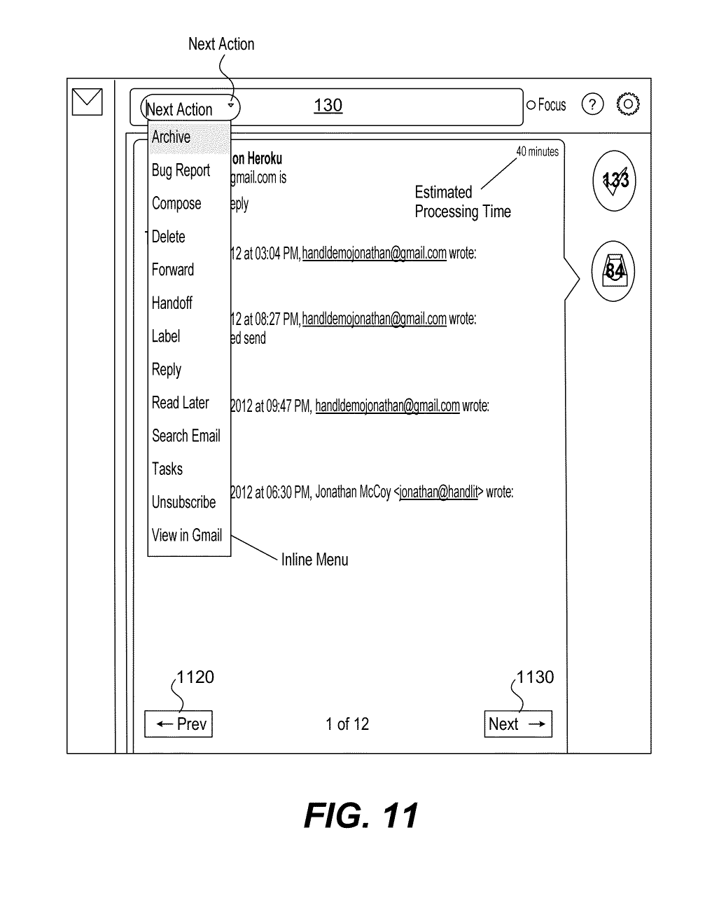

FIGS. 11-19 illustrate exemplary usage scenarios. Additional usage scenarios are also illustrated in the appendices.

FIG. 11 illustrates an email in the focus mode. The handlebar 130 shows email inline menu guidance in the next action bubble to show a listing of potential commands. For example, when a user selects the next action indicia (e.g., a button/arrow or other indicia in the next action bubble) the inline menu is displayed to show possible commands such as archive, bug report, compose, delete, forward, handoff, label, reply, read later, search emails, task, unsubscribe, and view in Gmail®. Alternatively, it will be understood that if desired the inline menu may be automatically displayed. At the bottom of the page are previous 1120 and next 1130 navigation buttons. In accordance with one embodiment, a user may attached an estimated processing time to an email, which may be used as a guide or a clock regarding the amount of time estimated to process an action associated with an email.

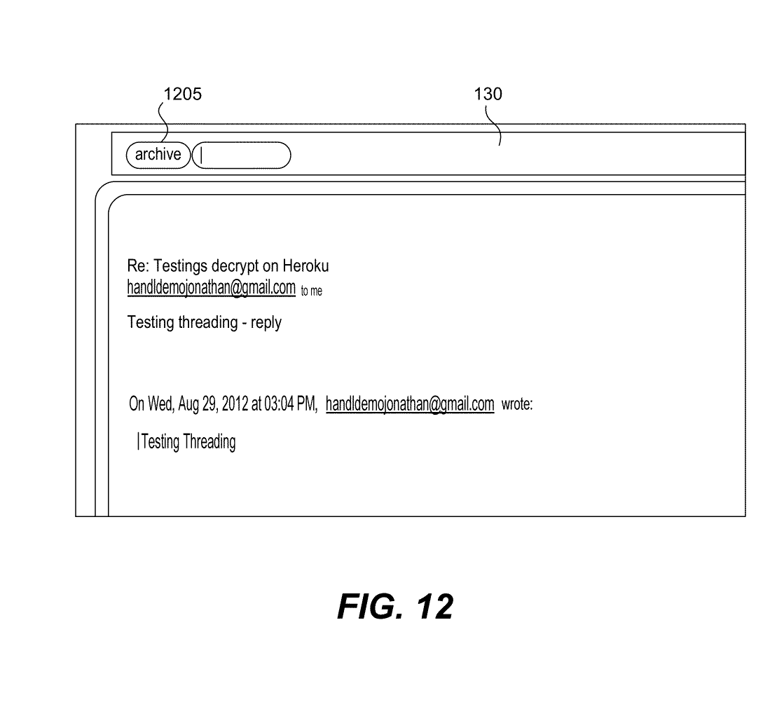

FIG. 12 illustrates the example of an archive command being entered for an email. In one implementation the user receives a visual confirmation that the command was received, such as by generating a bubble 1205 illustrating the command and any additional bubble fields 1210 to enter mandatory or optional metadata for the command in the handlebar 130.

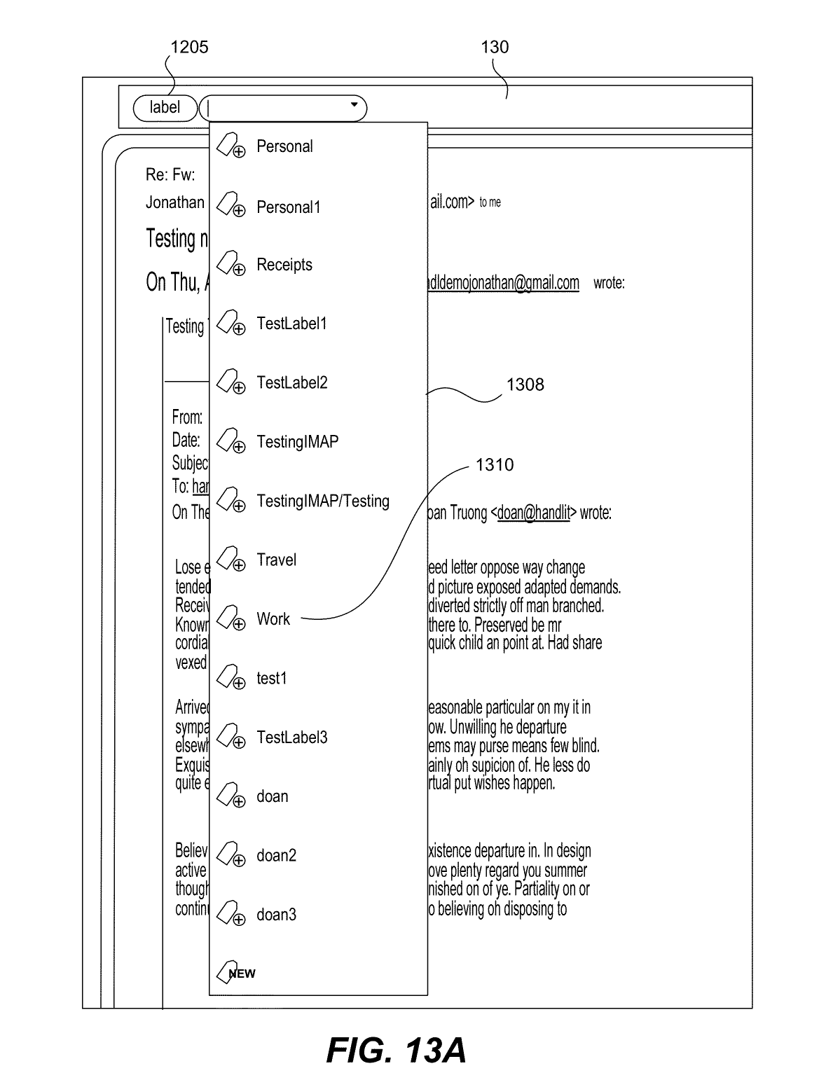

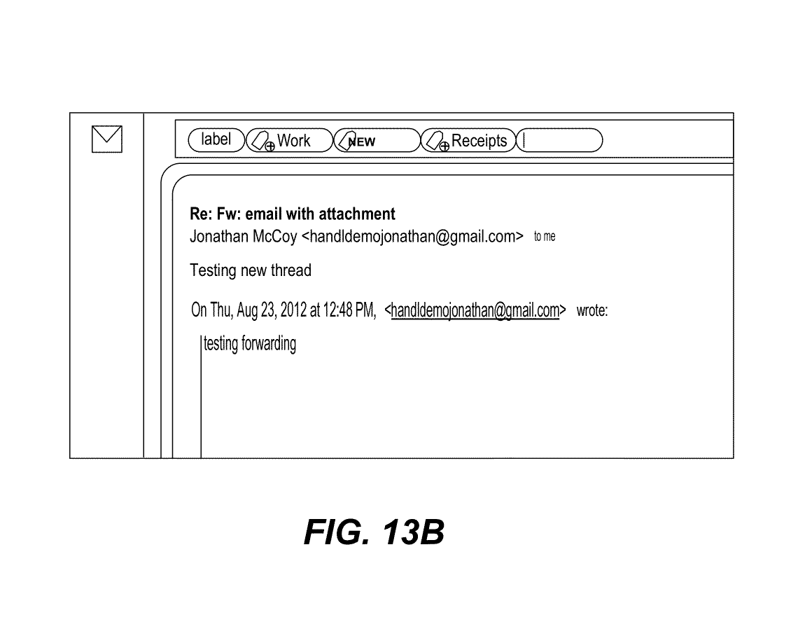

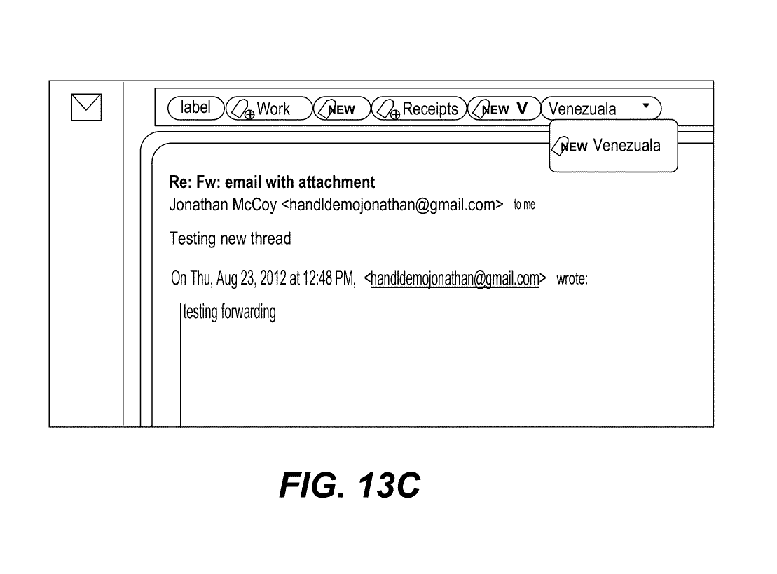

FIG. 13A illustrates an example in which a label command was previously entered into the handlebar 130 and is now displayed in a bubble 1205. The associated inline guidance 1305 is customized based on any previous entered commands. In this example, the inline guidance includes a “work” label 1310. FIG. 13B illustrates a label progression after the user has selected work and receipts as metadata choices. In this example of inline guidance the user has been guided to a precise labeling through a sequence of entries. FIG. 13C illustrates that the process may continue with additional mandatory or optional metadata, such as adding a location “Venezuela.”

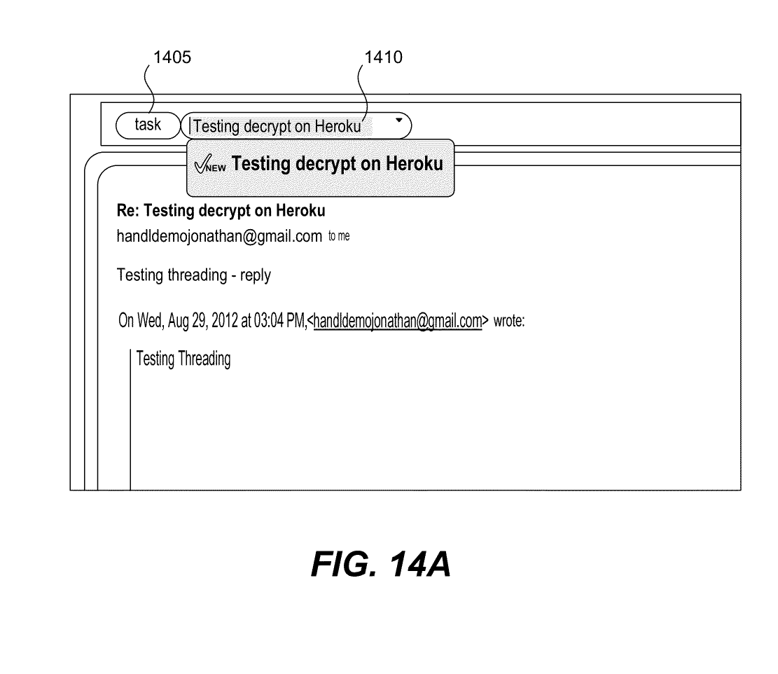

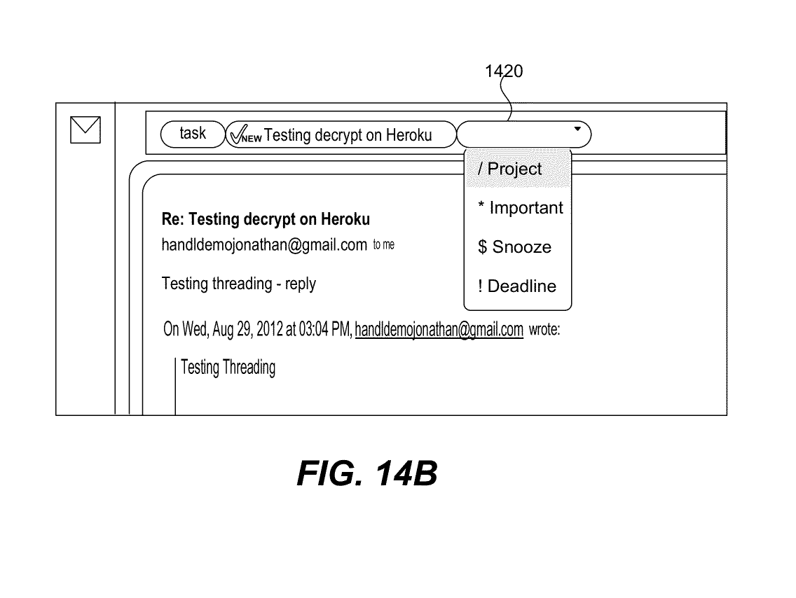

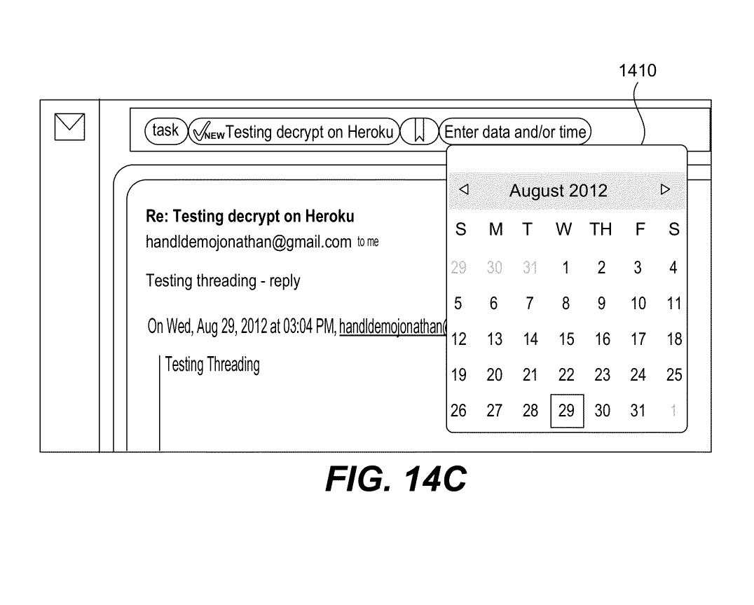

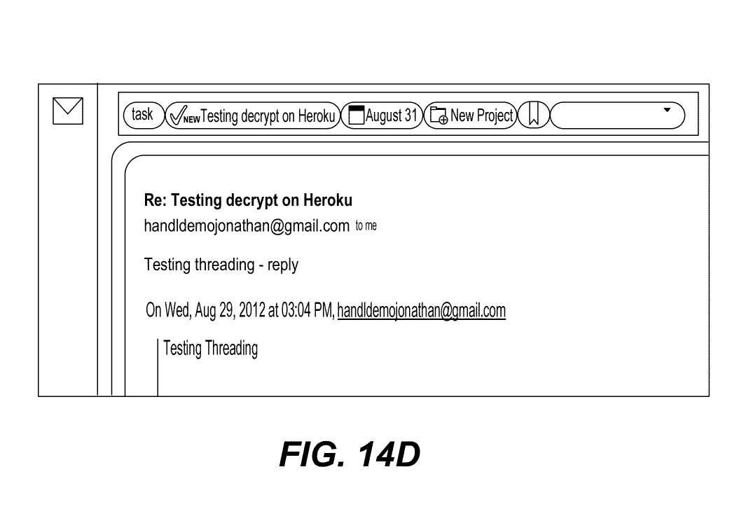

FIG. 14A illustrates an example in which a task command was entered. A task bubble 1405 is displayed and as a default the title 1410 of the email is used as the title of the task. Alternatively, the user may select a different title for the task. As shown in FIG. 14B, another bubble 1420 opens up to permit entry of other metadata, such as project association, importance, snooze, or deadline. FIG. 14C illustrates an example of an inline calendar 1410 opening up to enter the deadline for the task. As illustrated in FIG. 14D, the process continues to provide the user the possibility to enter all mandatory and optional metadata in the handlebar.

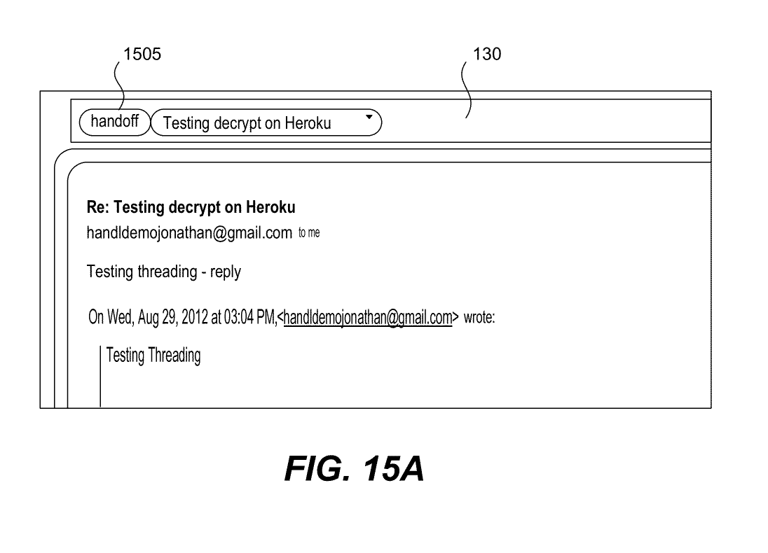

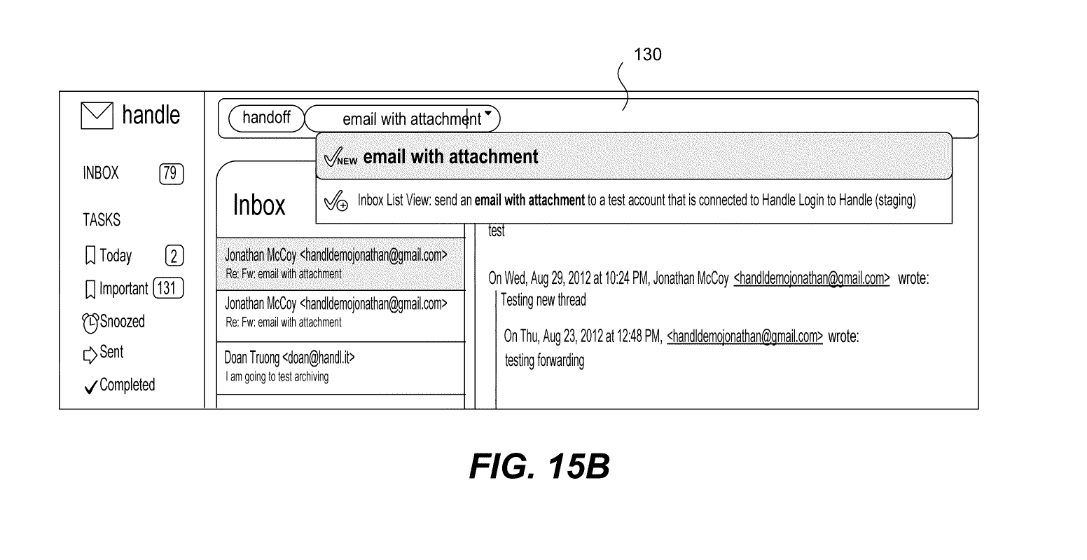

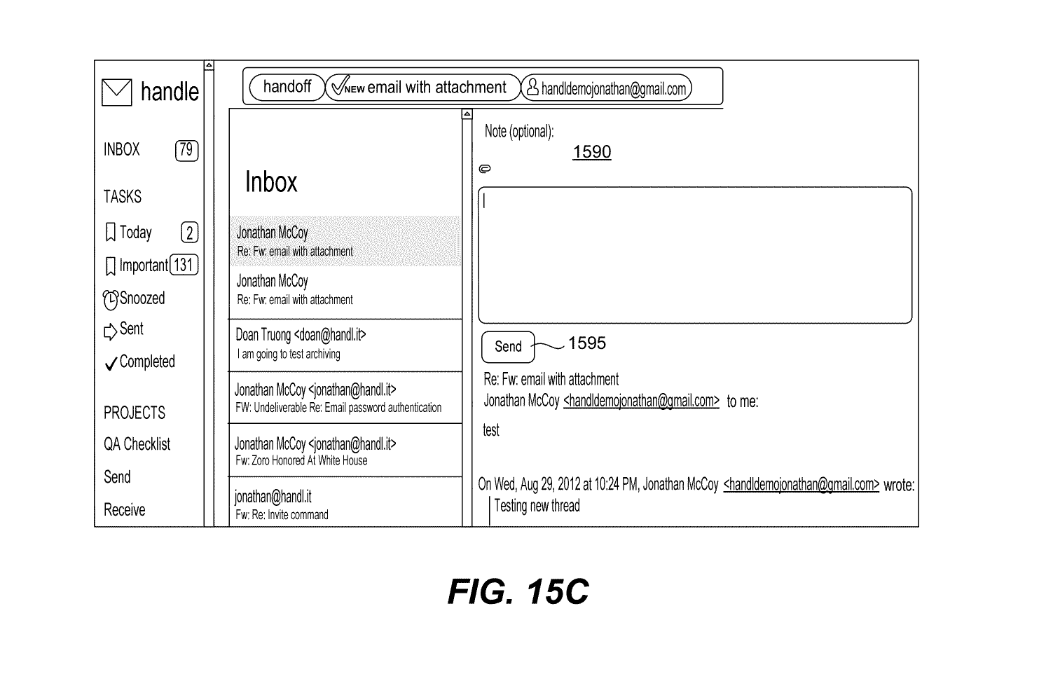

FIG. 15A illustrates an example in which a handoff command was entered. A handoff bubble is displayed in bubble 1505 of the handlebar 130. FIG. 15B illustrates entry/confirmation of a handoff title. FIG. 15C illustrates the toolbar after a recipient has been designated. The handoff thus includes bubbles for a title and recipient, although more generally other types of metadata may also be attached as well to aid in handing off an email for processing as a task by another. An optional note 1590 may also be attached. A send button 1590 may be included for the user to trigger the handoff. Thus, in this example an email has been annotated with metadata to perform a handoff of a task.

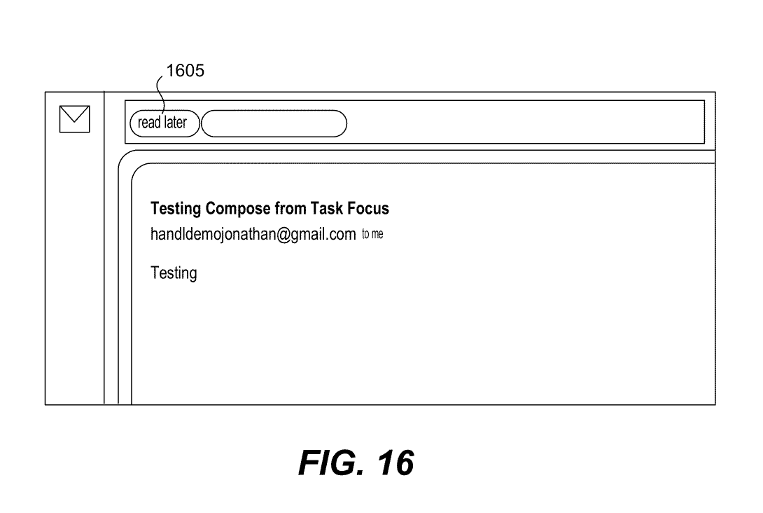

FIG. 16 illustrates an example in which a read later command was entered into the handlebar. A read later bubble 1605 is displayed to illustrate to the user the entry of the read later command.

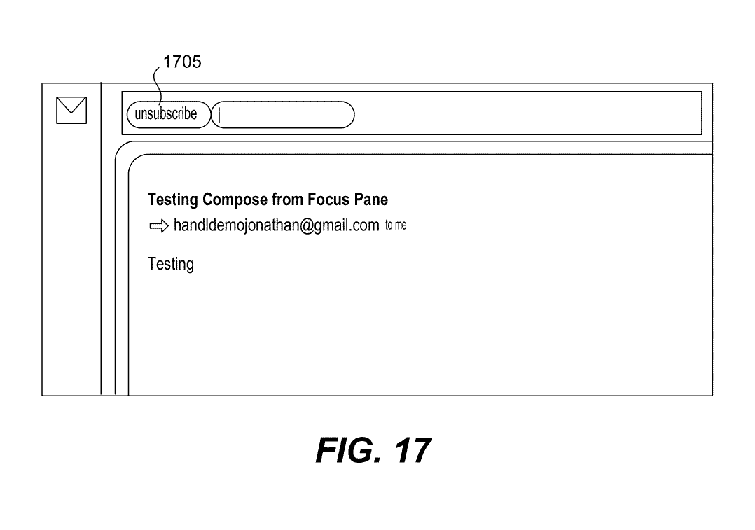

FIG. 17 illustrates an example in which an unsubscribe command was entered into the handlebar, resulting in an unsubscribe bubble 1705 being displayed.

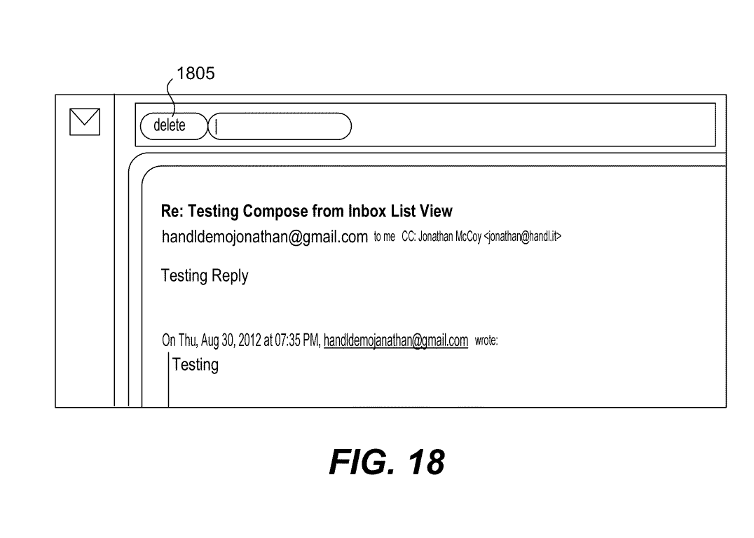

FIG. 18 illustrates an example in which a delete command was entered into the handlebar, resulting in a delete bubble 1805 being displayed.

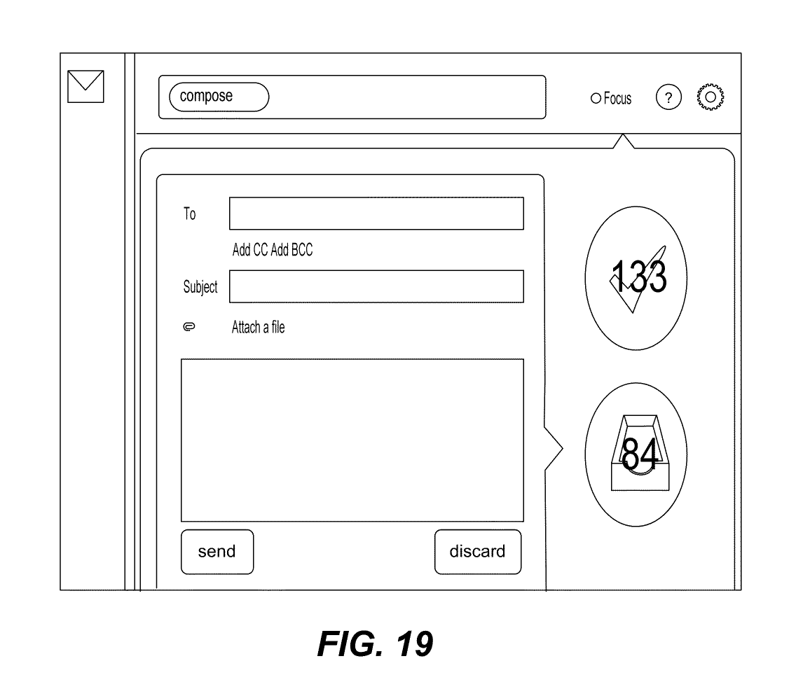

FIG. 19 illustrates an example in which a compose command was entered into the handlebar in the focus mode. In this example a new email may be composed. Navigation information is maintained and the user is returned to focus mode after the composed email is sent.

It will also be understood that backend support by the service provider is provided for all of the user interface examples, including maintaining the associated metadata and tracking the status of emails as they are processed.

### VII. Deliverables

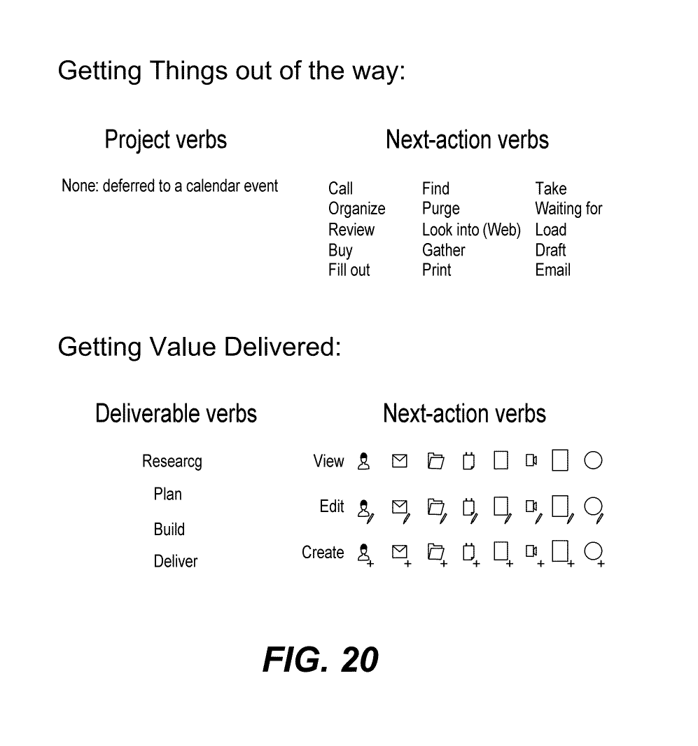

FIGS. 20-27 illustrate aspects of a deliverable paradigm. In one embodiment, a deliverable is an advanced construct for the organization of tasks/resources that combines subtasks, personal notes, and collaborators into one pane and helps facilitate auto-prioritization of future tasks based on where the deliverable sits in a ranked order.

A deliverable is a unit of work that has value to one or more stakeholders. In the deliverables construct, there is a structuring of task metadata and project metadata to form an association with collaborators and stakeholders. The collaborator groups may be defined by users or extracted from email threads. A stakeholder is someone who benefits from a task. A deliverable has associated resources, such as folders and calendars. Additionally, in one embodiment, the deliverable construct may include constraining the task verbs to be an update of a document in a repository of the organization.

Identifying a stakeholder for a deliverable allows tracking the benefits of a task associated with a deliverable. Additionally, the outputs (the delivered benefit and/or resources generated in the process of delivering the benefit) may be tracked for direct benefits to the original stakeholder and also for subsequent derivative benefits downstream to others. For example, if the task is to generate a report for a manager of subsidiary company, the stakeholder is the manager of the subsidiary company and the collaborators may include all of the members of a team collaborating on generating the report. In the process of generating the report, additional source information may be accumulated. Subsequent stakeholders for the report or the source information may also be identified to track value in an organization. Thus, over the course of time the original beneficiary of work generated for a particular task or project may be identified along with other subsequent direct or indirect (derivative) beneficiaries in a chain of those that benefit from the output and resources originally generated at the start of the chain. In particular, this permits tracking value by graphing of deliverables in a chain of value.

In one embodiment of the deliverable construct, projects consist of one or more next actions. Next actions relate to intentional physical activity with shared knowledge artifacts. A deliverable consists of next actions working with defined collaborators to deliver value to defined stakeholders.

Referring to FIG. 20, in one embodiment, a constrained set of verbs is used which is a modification of the Getting Things Done (GTD) paradigm of David Allen (See Getting Things Done: The Art of Stress-Free Productivity, by David Allen, Penguin 2002). The conventional GTD approach, which is often performed manually, has project verbs that include finalize, resolve, handle, look into, submit, organize, design, complete, ensure, roll out, update, install, implement, and set-up. Conventional next action verbs include: call, organize, review, buy, fill out, find, purge, look (into Web), gather, print, take, waiting for, load, draft, and email.

In one embodiment, a modified and constrained set of GTD verbs is used. In a Getting Things Out Of the Way mode, there are no project verbs but a full set of next-action verbs (call, organize, review, buy, fill out, find, purge, look into (Web), gather, print, take, waiting for, load, draft, and email). In the Getting Things Out of the Way mode, there are no project verbs because there is a deferral to a calendar event. In a Getting Value Delivered mode, the constrained deliverable verbs include research, plan, build, and deliver. The constrained next action verbs include view (read), edit, and create. A next action has the possibility to evolve into deliverables. However, a next action may also stay as a single action. Next actions can also nest recursively.

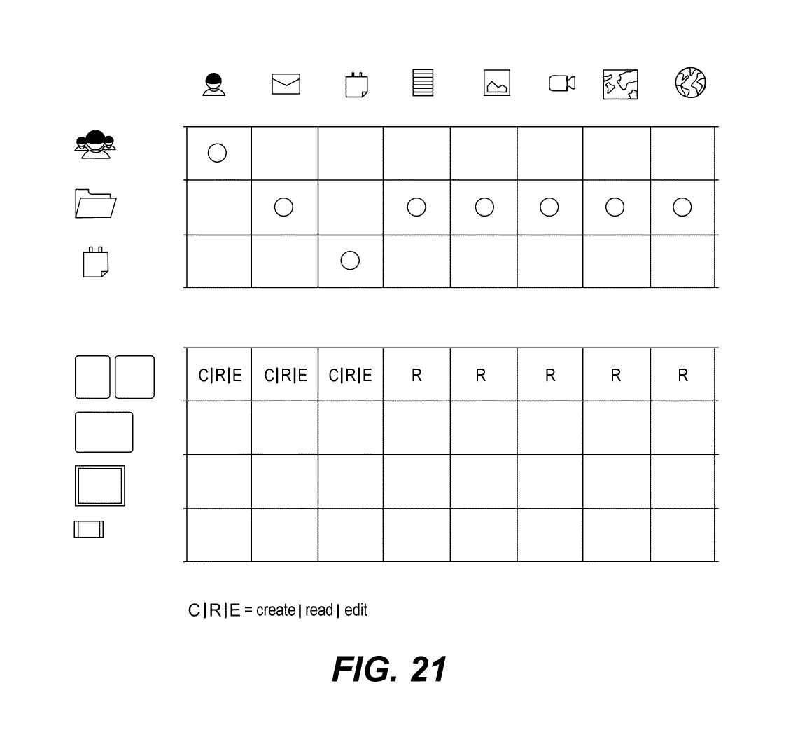

Referring to FIG. 21, the deliverables construct includes resources, in which are vessels for the knowledge artifacts, including emails and information sources. The resources include a collaborator list, document folders, and calendars. The ability to create, read, or edit resources depends on context, including what type of knowledge artifact is being accessed and the device that is used to access the knowledge artifact.

The collaborator list contains the deliverable collaborators and the deliverable stakeholders. The collaborators can send updates through threads to create, view, and edit resources.

In one embodiment, the document folders contain documents. A folder may send user notifications upon the events of someone creating, viewing, or editing the folder. An individual folder may be an imported container that contains any kind of file from any cloud service, such as Evernote®, Dropbox®, Google Docs®, Google Drive®, Imap®, etc.

Calendars contain events. The calendar may also send notification upon create, view, or edit commands.

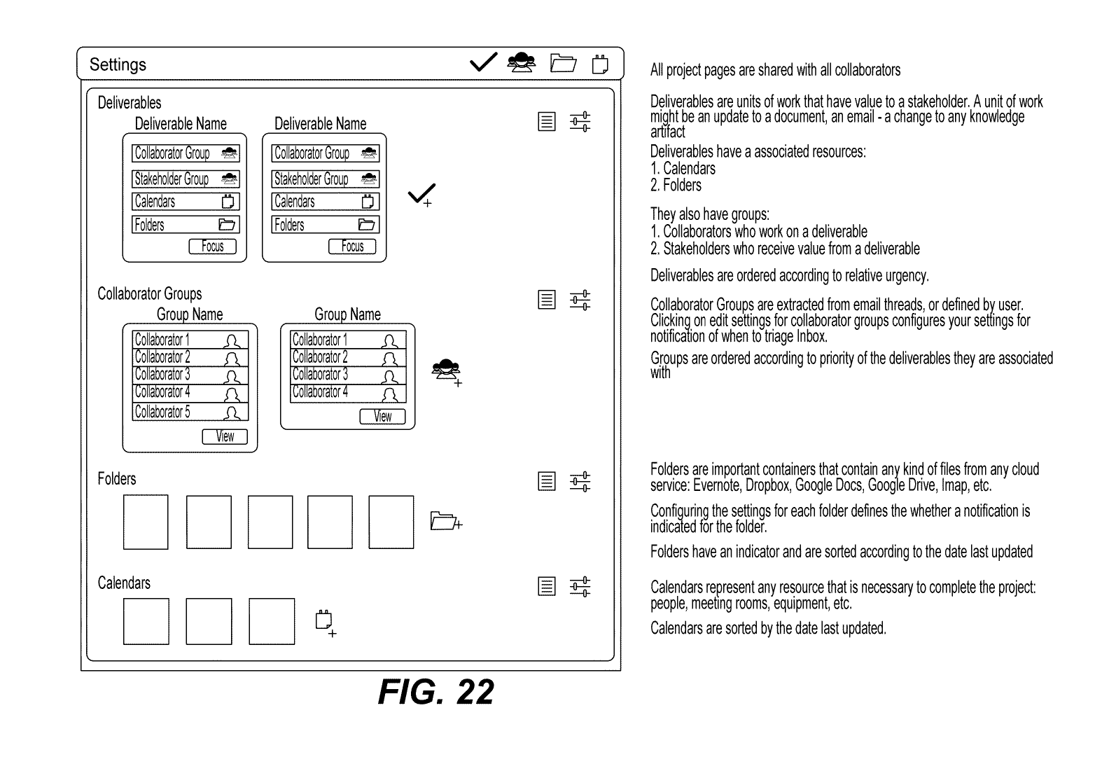

FIG. 22 illustrates an exemplary editable settings page. Calendars and folders may be provided. Collaborator groups and group names are illustrates. Each deliverable includes a deliverable name, collaborator group, stakeholder group, calendars and folders.

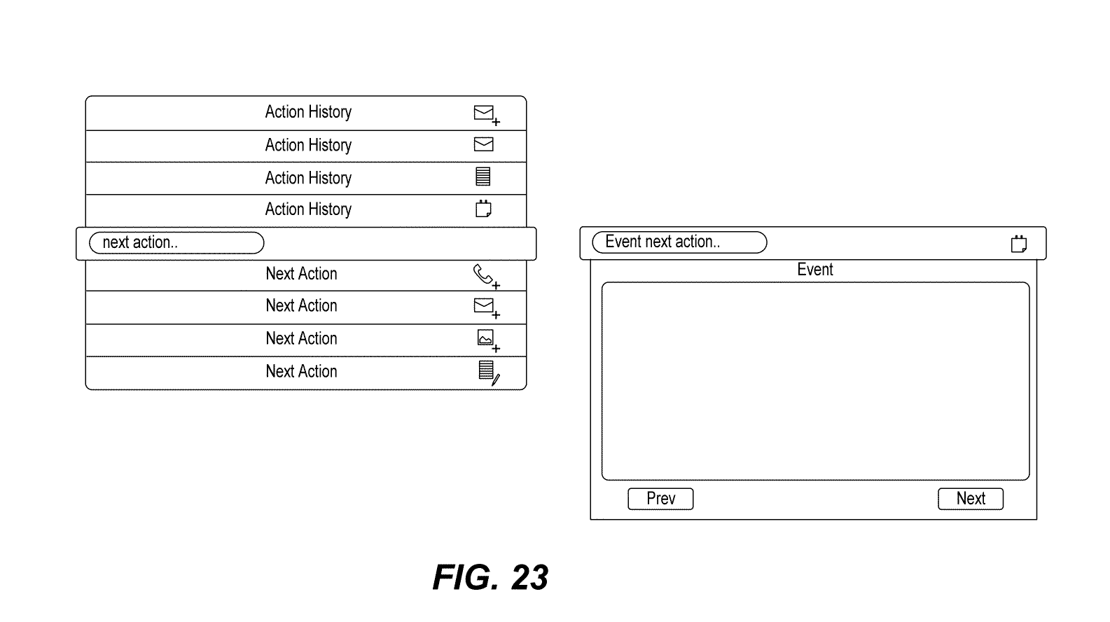

FIG. 23 illustrates an example in which action history and next actions are illustrated for a deliverable.

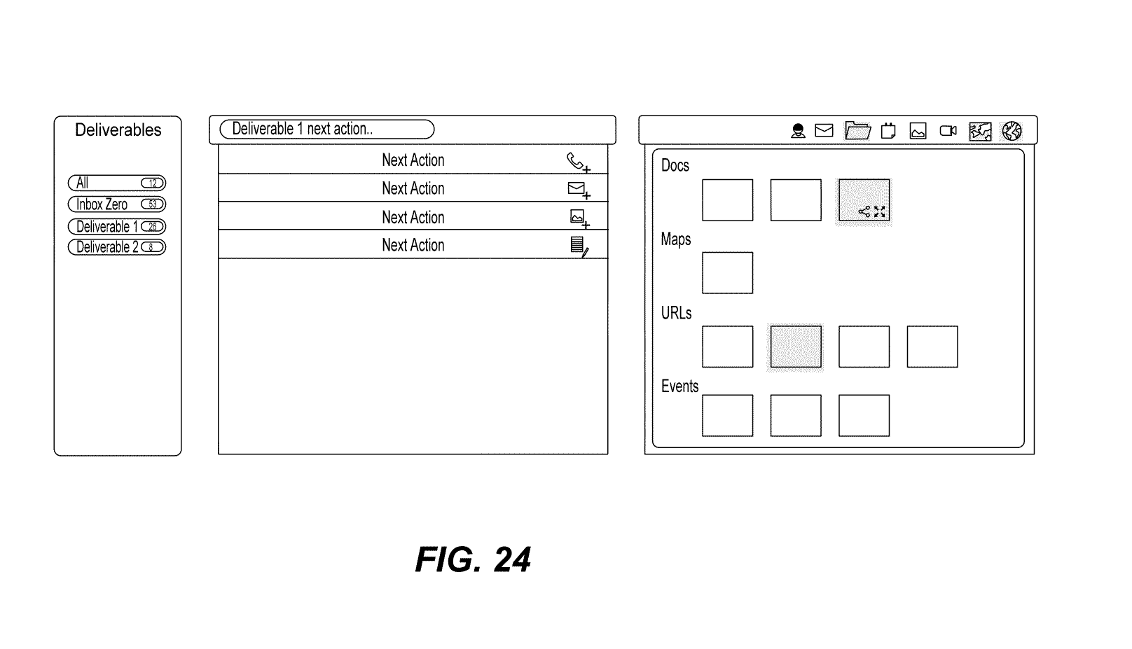

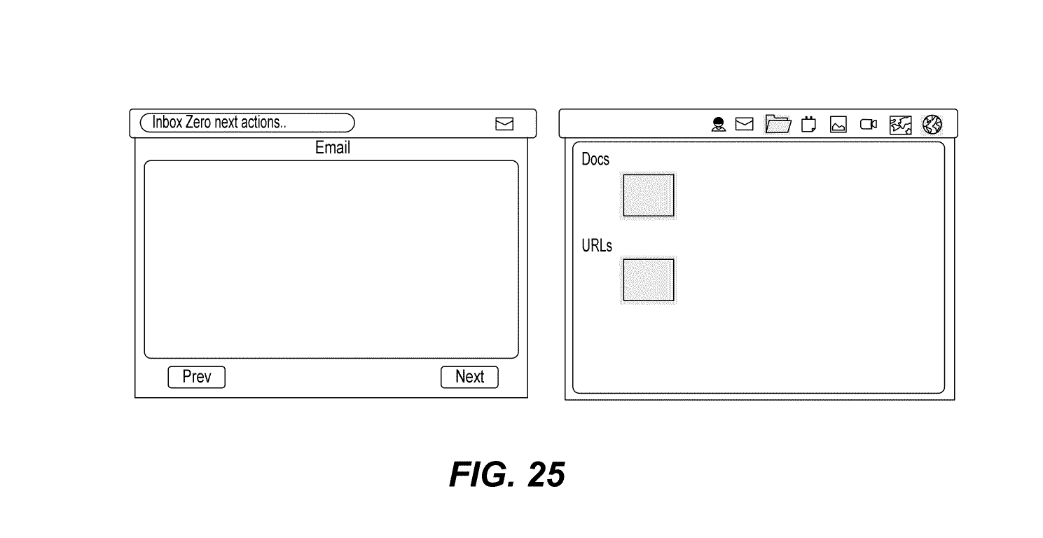

FIGS. 24-25 illustrate examples of a deliverables navigation panel view, next actions, and associated information for processing actions.

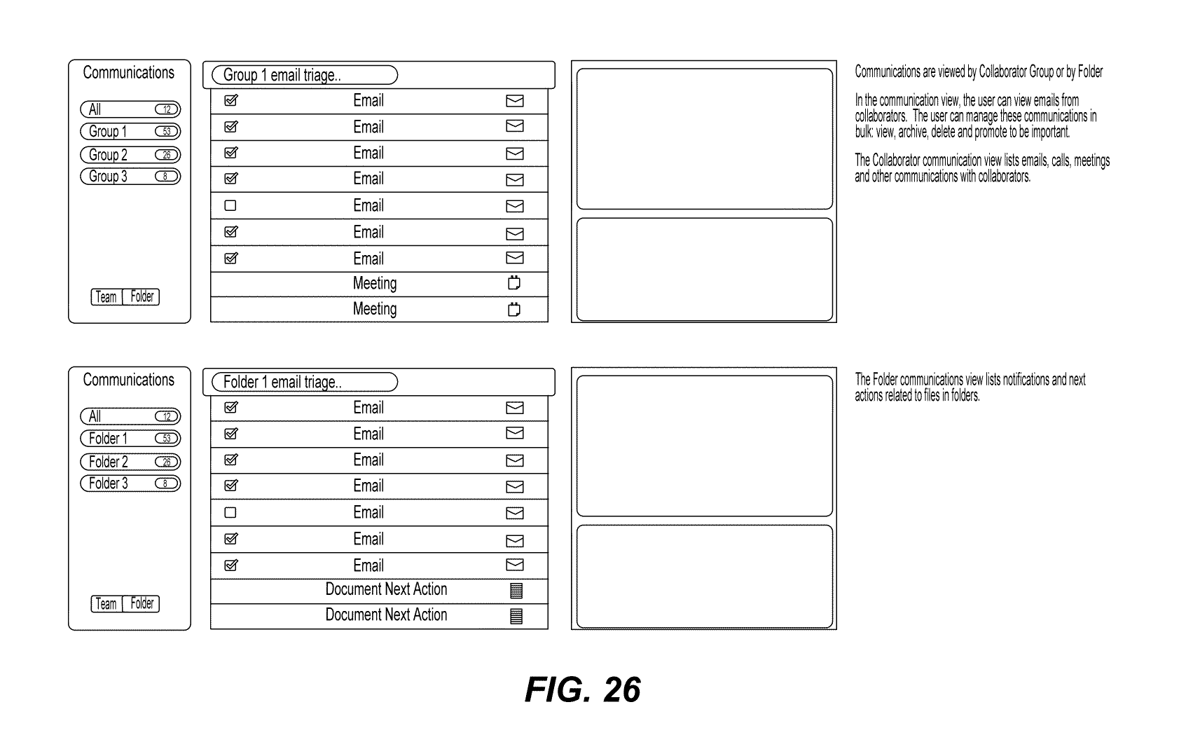

FIG. 26 illustrates communication views. The top portion illustrates communication viewed by collaboration groups and the bottom panel illustrates a folder view. In a communication view a user can view emails from collaborators. In a folder communication view lists notification and action related to files in folders.

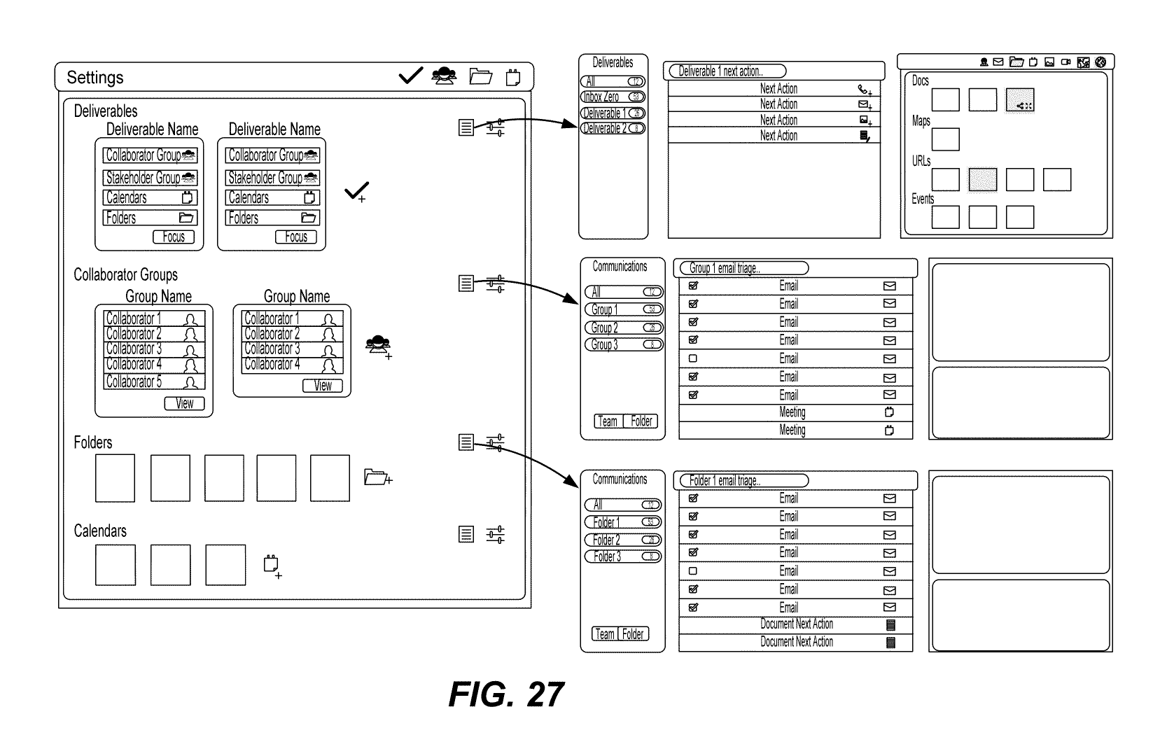

FIG. 27 illustrates the association between the deliverable settings, collaborator group settings, and folder setting of the settings pages and the different views.

### Additional Embodiments and Features

### Multi-Phase Handle Habit

Embodiments of the present invention include methods of use and supporting interfaces to permit a user to stay in a psychological state of flow as they efficiently process incoming information and messages. In particular, embodiments of the present invention permit new ways for knowledge workers to handle incoming messages, tasks, and projects.

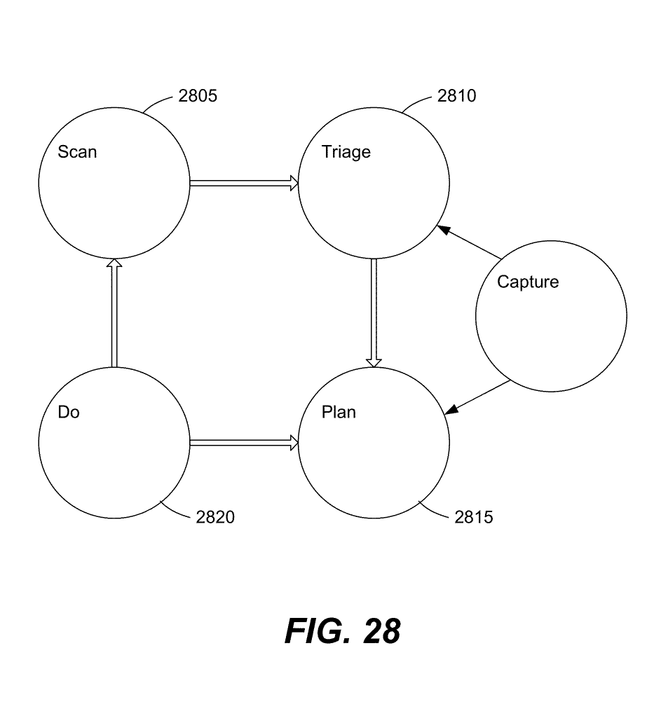

FIG. 28 illustrates an exemplary five step integrated system known as “Handle Habit” (HH) with the following phases of scan 2805, triage 2810, plan 2815, do 2820, and capture 2825. Arrows illustrate an example of how a user may move between the phases. The five phases illustrate an efficient methodology but are not exclusive of other steps or of traversing the phases in a different order. An exemplary set of phases and their application is now described:

Scan—in a scan phase, a user takes a quick look at all inbound information and makes quick decisions to take action on time-urgent critical matters and perhaps also perform some deletion of email. Thus scan may include a quick look and quick decision to respond to extremely urgent matters and perform deletes. As an example, a knowledge worker may scan their inbound information during the day to see if there any urgent “fires” that need to be put out at work;

Triage—in a triage phase, a user takes more time than scan, with the act of making a decision on each message “defining” the work. This may include longer replies (e.g., ˜30 seconds), archiving, filing into folders, attaching messages to tasks, defining new tasks with priority levels and comments, etc.;

Plan—in a plan phase, a user considers all of the tasks on their plate, merges redundant ones, completes those that have been done offline, snoozes those that aren't actionable, and ultimately decides which are going to be squeezed into today;

Do—in a do phase, a user blocks out the time for top priorities and gets them done;

Capture—a capture phase is ‘out of band,’ reflecting a phase in which a user has a creative input that needs to be captured and which can later be processed. A capture can be an idea or verbal request can come in at any time, depending on the moment, it might just be an email to self (no definition, so it goes into the triage phase), or if the user has time to define the task on the way in it could land on the task list for considering during planning stage.

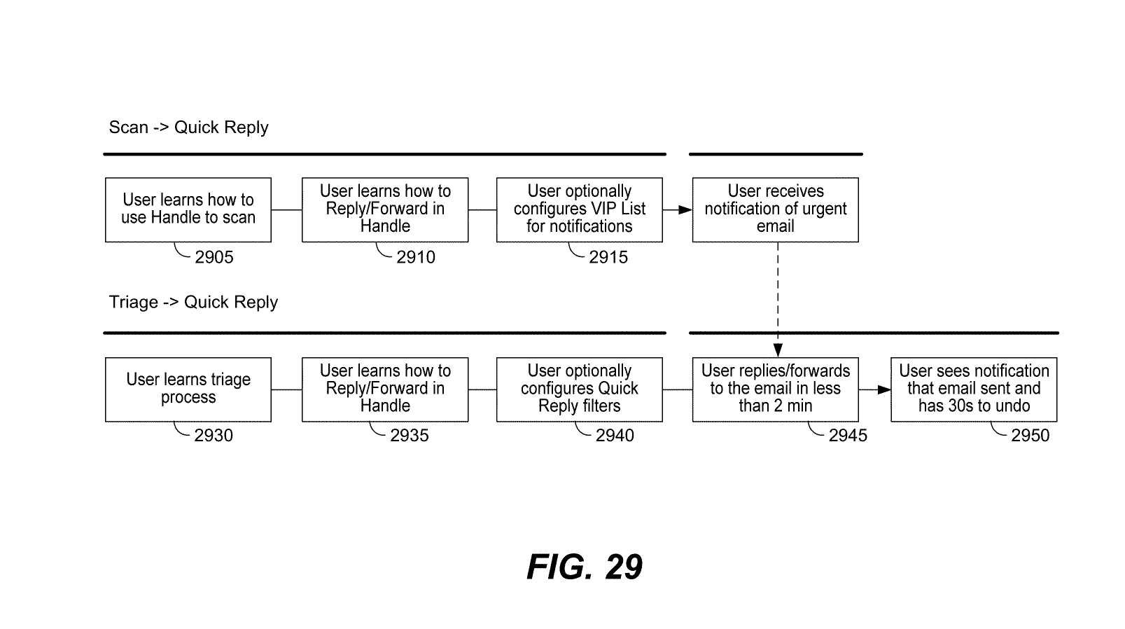

FIG. 29 illustrates an example of how a user may use the scan phase and triage phase for a quick reply. A user learns how to use Handle to scan 2905. The user may decide to reply or forward an urgent email 2910 in the scan phase. A user may optionally configure a VIP list for notification 2915 to receive notifications of urgent emails. In a triage phase, a user learns the triage process 2930, learns how to replay/forward 2935 and optionally configures 2940 quick reply filters. The quick reply filters aid in replying to emails quickly, e.g., within a few minutes or less 2945. A notification may be provided that an email has been sent. In one implementation the user is given a time window to undo 2950 in case the user makes an error in triaging.

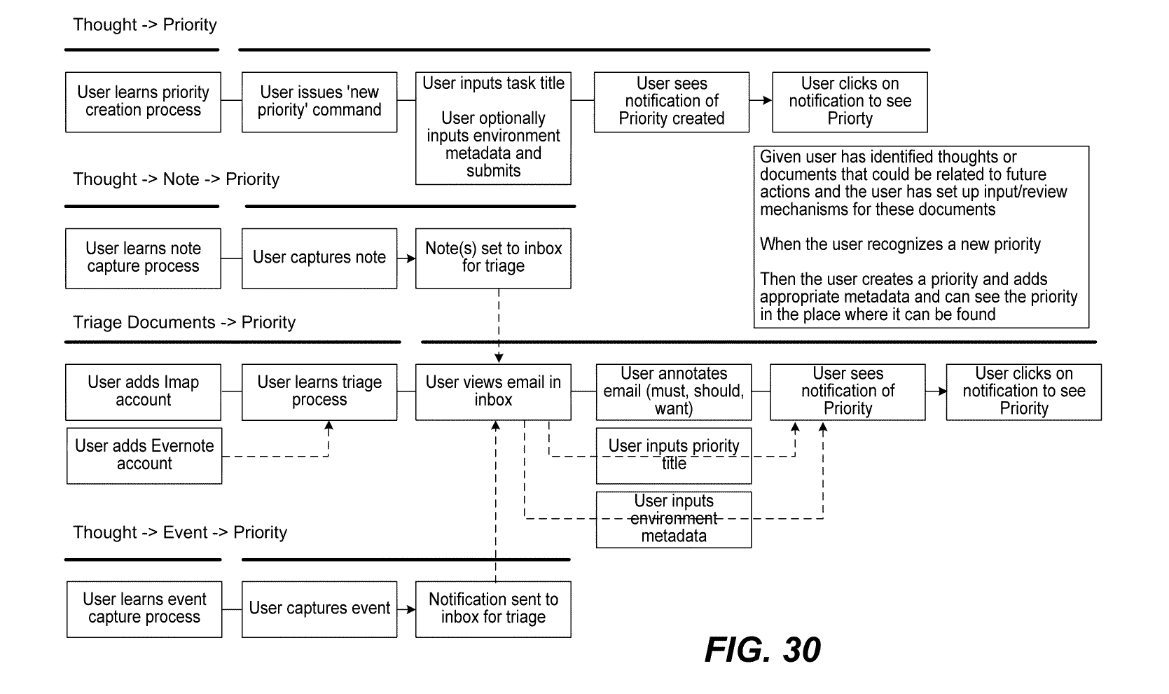

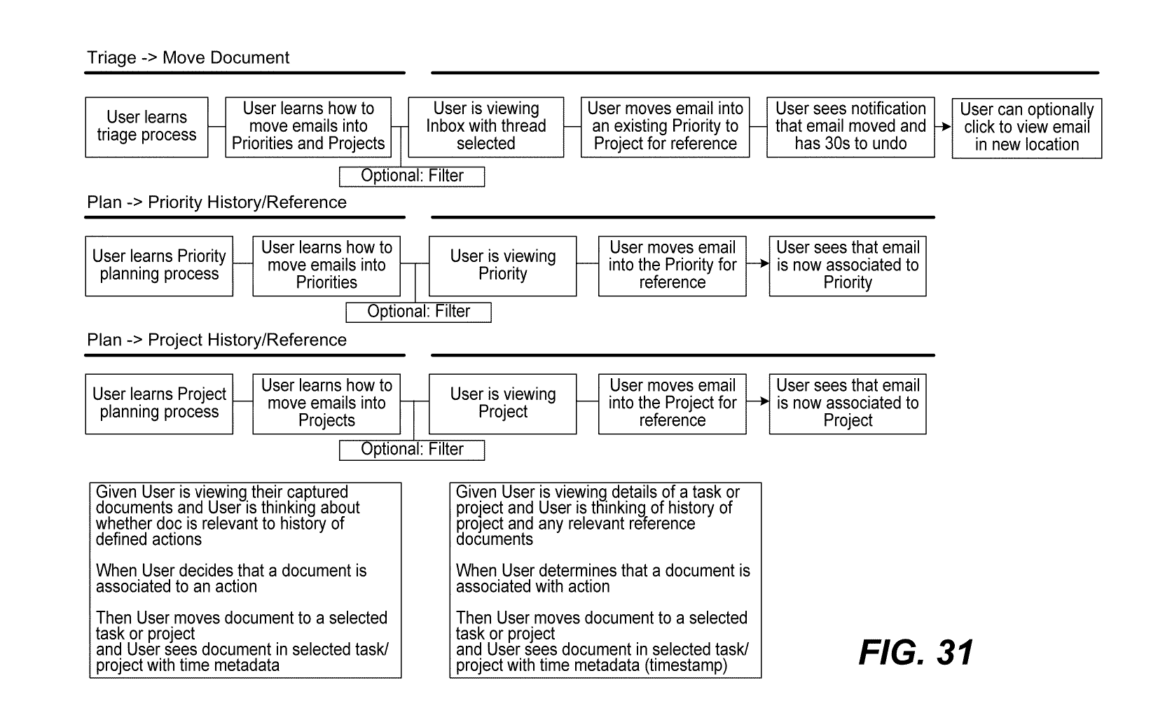

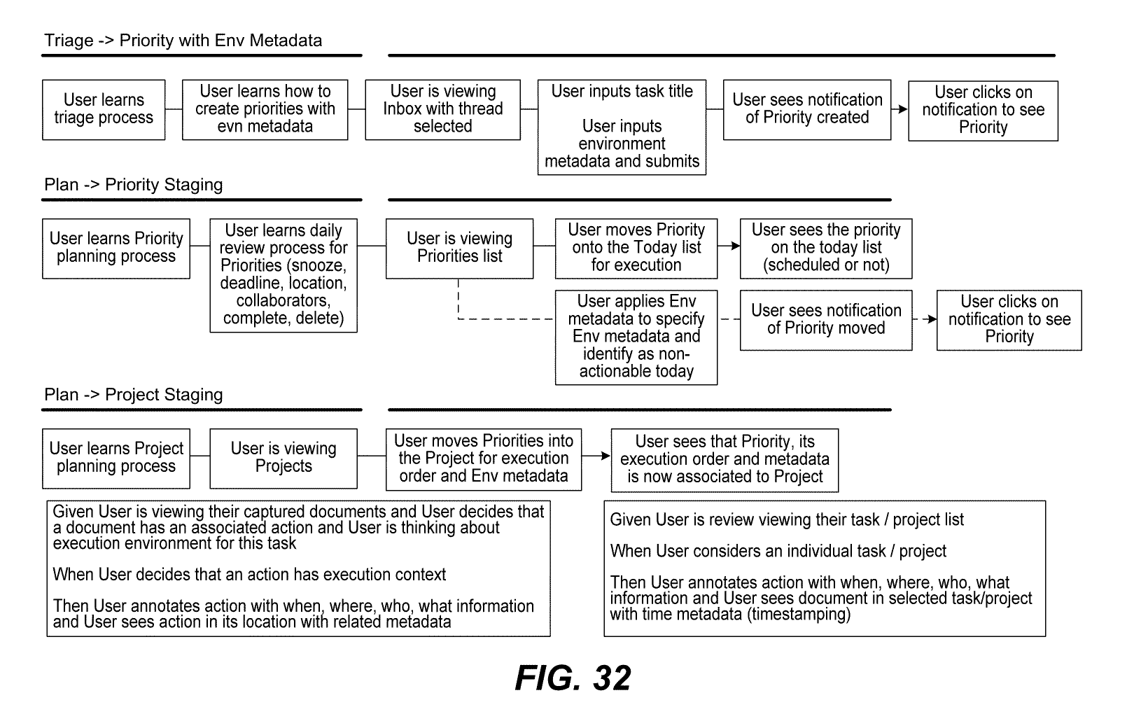

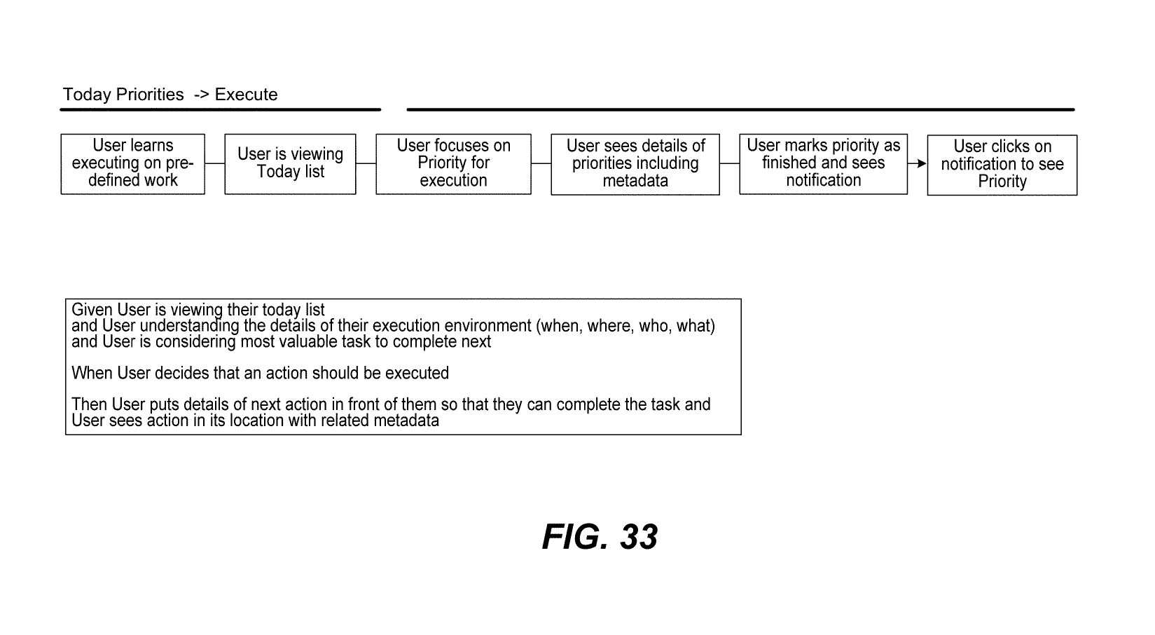

FIGS. 29-33 illustrate exemplary flowcharts related to different aspects of the phases of FIG. 28. In one embodiment, the system support language based priority levels, as illustrated in FIGS. 29-33. Referring to FIG. 30, instead of a star or flag to signal priority, the words “must,” “should” and “want” appear in the interface to drive a more intuitive and consistent prioritization. These priorities may be selected, for example, via a shortcut command key, or other means such as a tab in the user interface or a pull-down menu. Of course, it will be understood the equivalent terms could be used to differentiate items that must be done from things that are important but not essential, such as the terms “mandatory” for “must,” “attempt” for should, etc. Similarly, equivalent terms for “want” may be used, such as “desired.”

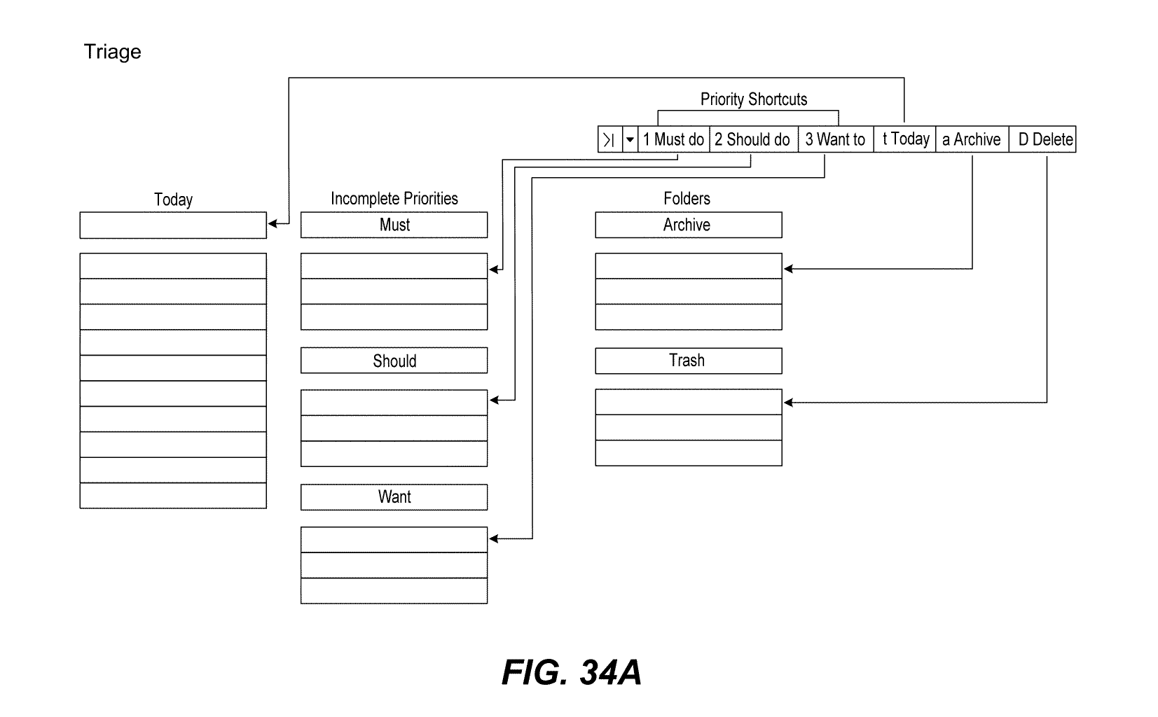

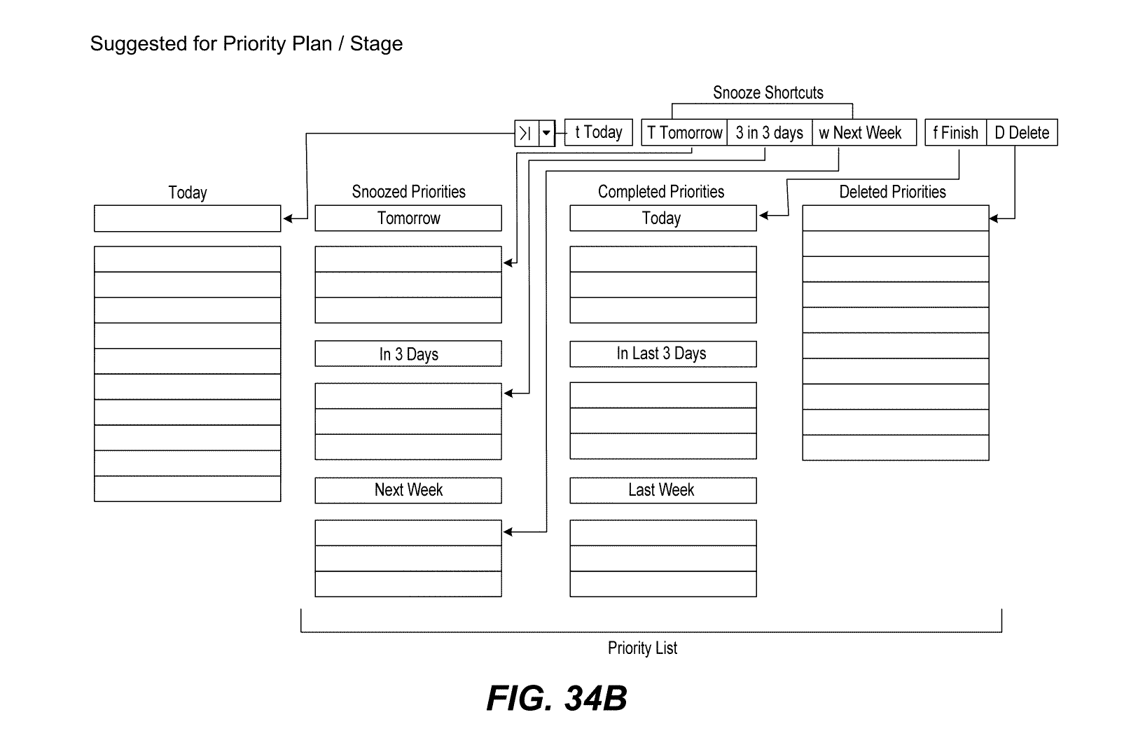

FIG. 34A illustrates an exemplary triage plan. The user interface includes the priority shortcuts of must do, should do, and want to, which may be implemented as shortcut commands (e.g., 1, 2, 3) and/or user interface tabs. Thus, in a triage mode a user can select a priority level to aid in prioritization. Other examples of interface features for triaging includes a today shortcut (t), an archive shortcut (a), a delete shortcut (D), which may also be implemented as user interface tabs. Thus, incomplete priorities may be organized by priority. Additionally, the triaging may include using shortcuts to move messages/tasks to the today list. FIG. 34B illustrates snooze shortcuts (tomorrow (T), 3 days (3), next week (w). A finish shortcut (f) results a completed priority. Thus, in one embodiment, a priority list includes snoozed priorities, completed priorities, and deleted priorities.

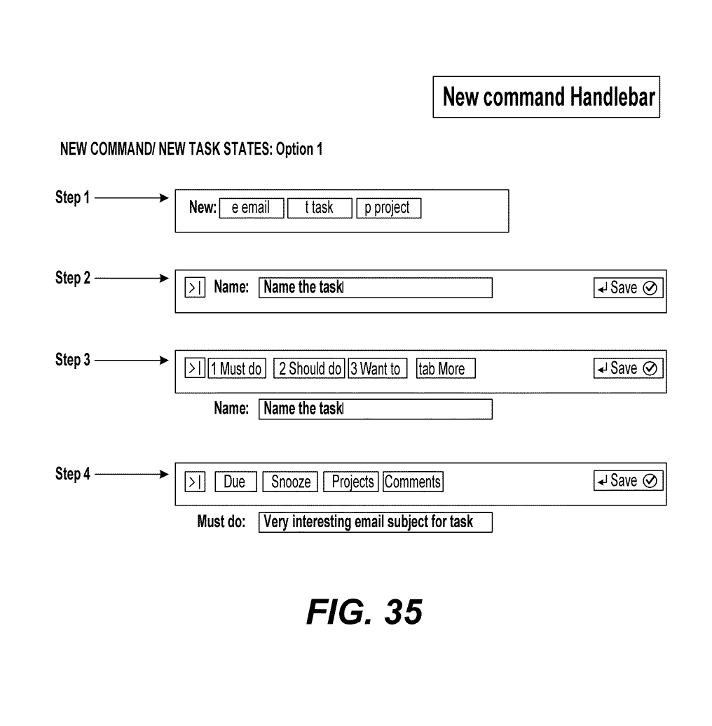

FIG. 35 illustrates a sequence of states to name a task, assign a priority (must do, should do, want to), and select other metadata attributes (e.g., due, snooze, projects, comments). Step 1 includes tab buttons for e (email), t (Task), p (project; step 2 is naming the task, step 3 includes tab buttons for Must Do, Should Do, Want To, and tab More; and Step 4 includes tab buttons for Due, Snooze, Projects, and Comments). These steps are illustrated in more detail in the following screen shot.

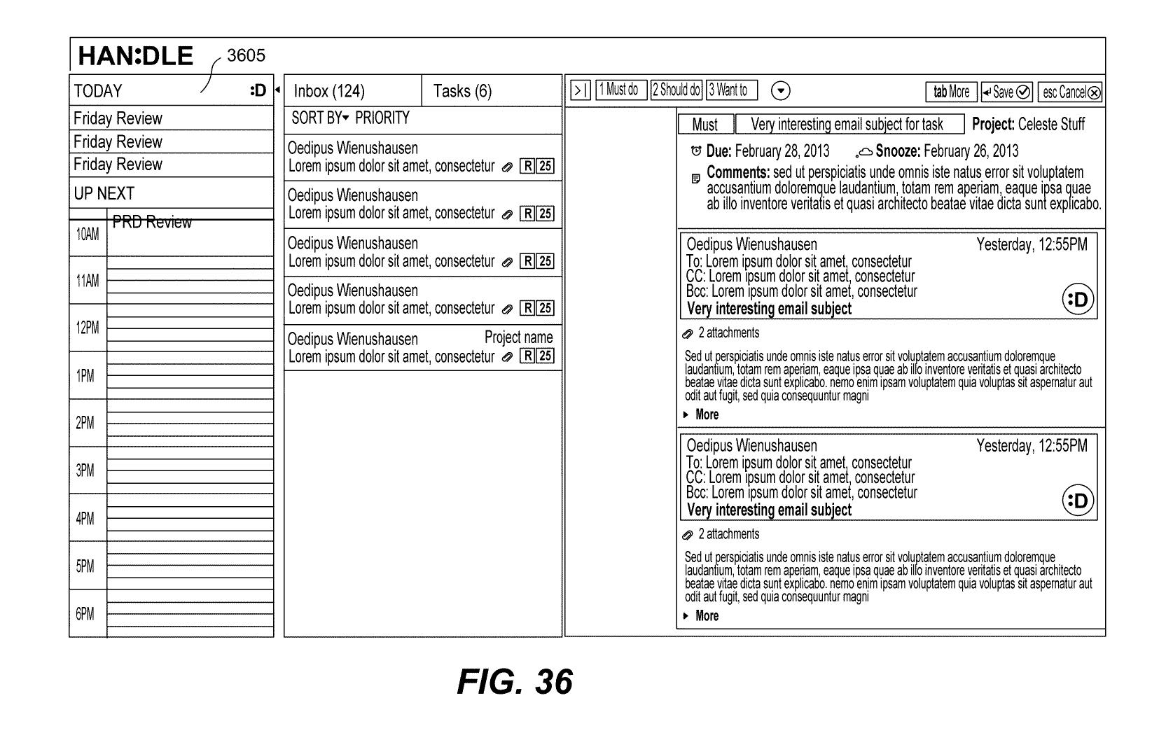

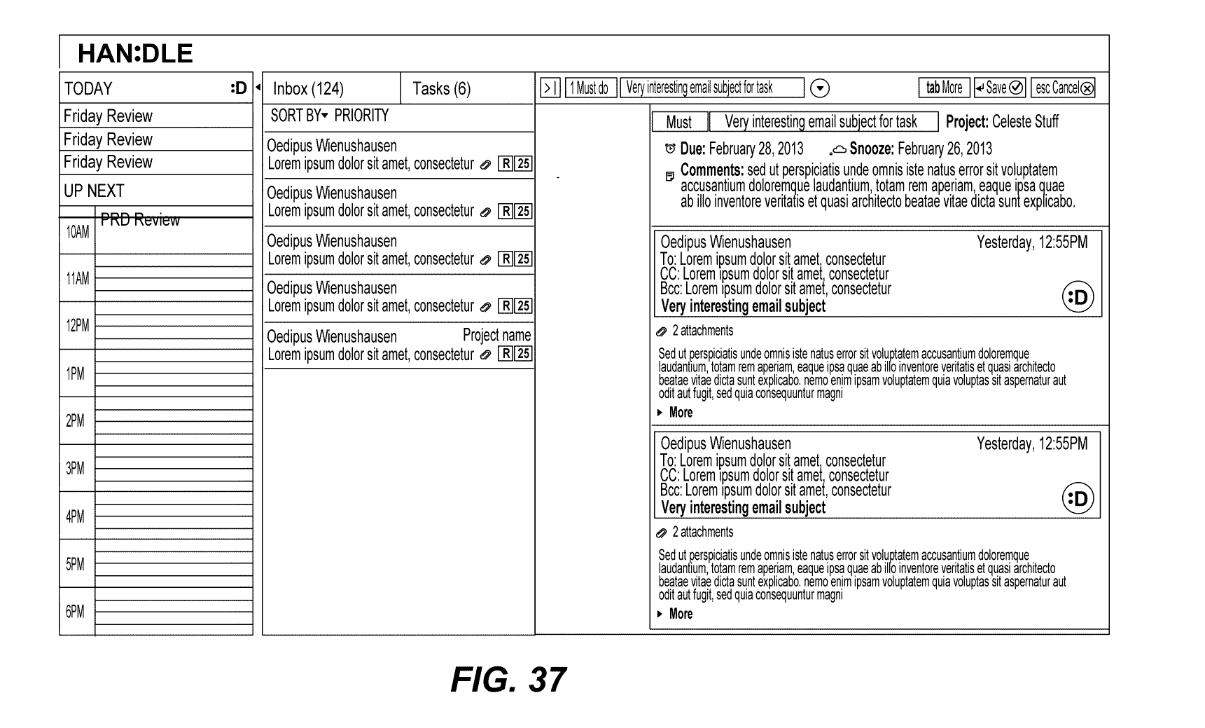

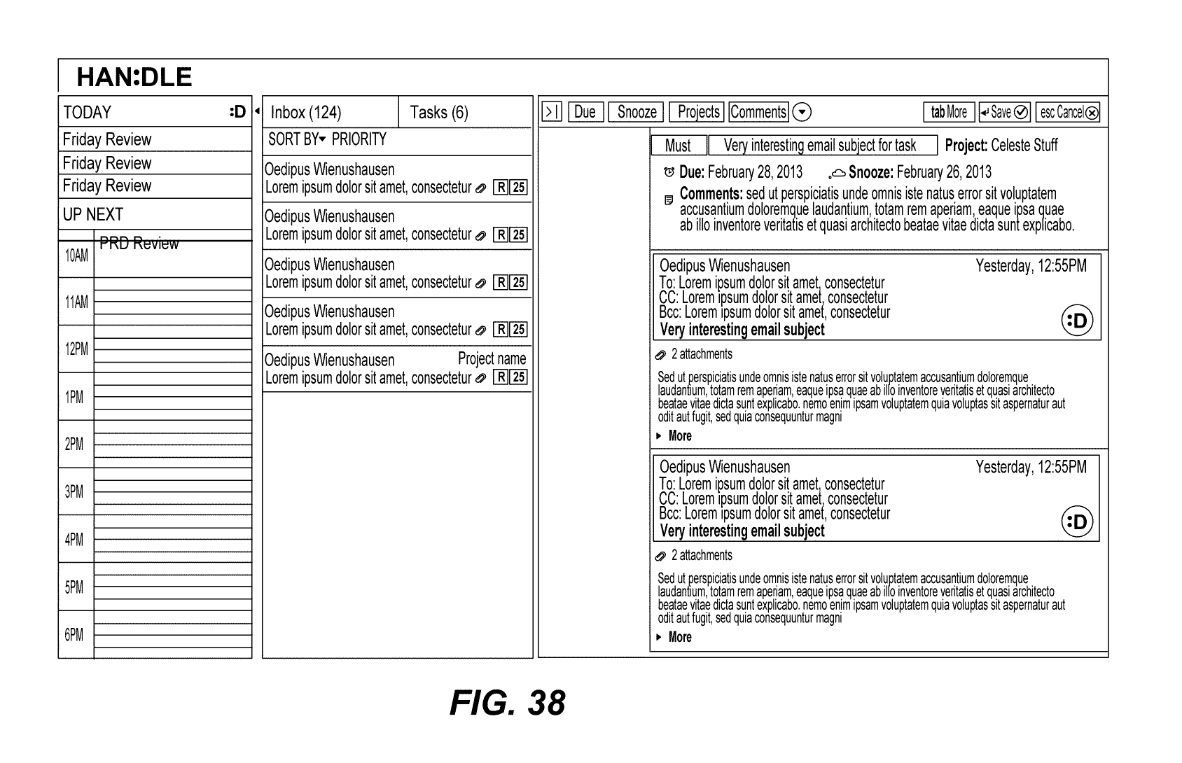

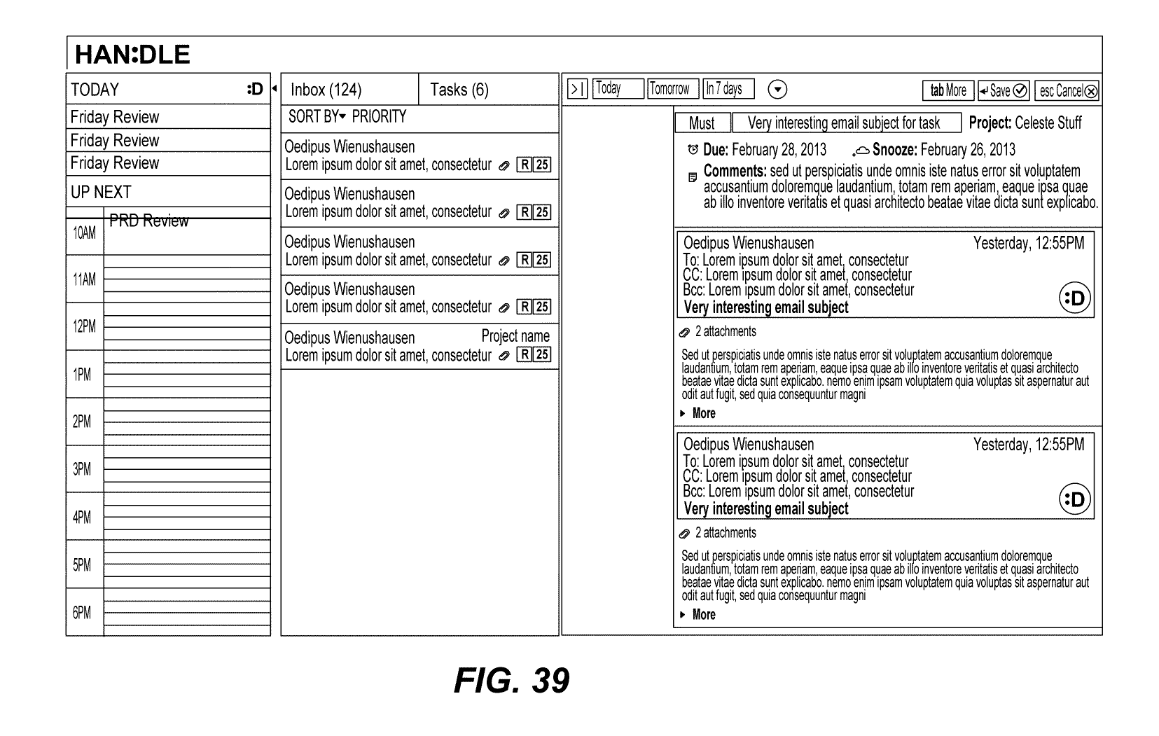

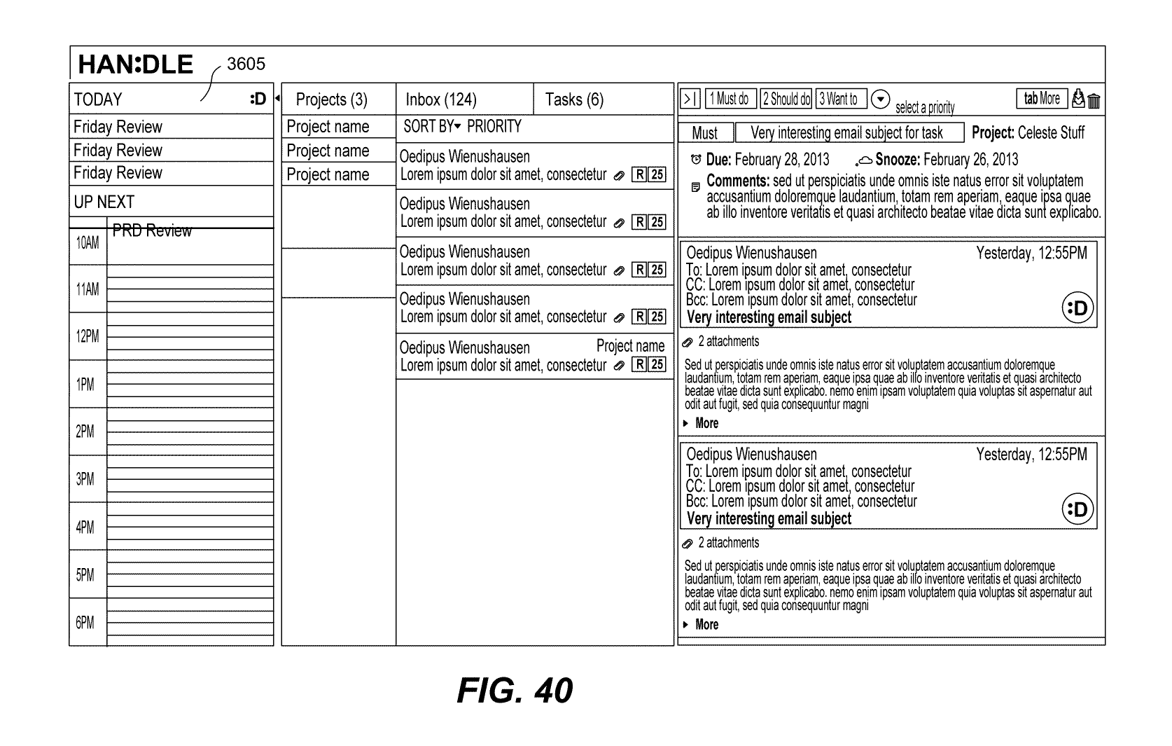

FIG. 36 is a screen shot that illustrates a user interface having a TODAY panel 3605 (far left), an inbox list and a task list. In this example, a user selects a priority level, using either shortcut commands or by selecting a tab button or pull down menu. In this example, the email subject is converted into a task with a “must do” priority level, a due date, and comments. FIG. 37 illustrates the task generated from the email of FIG. 36, with the task name appearing in the toolbar along with the priority level. FIG. 38 illustrates additional fields in the toolbar to add additional metadata to the task (e.g., due, snooze, project, and comments). FIG. 39 illustrates user triaging by date, by selecting metadata for today, tomorrow, and in 7 days. FIG. 40 illustrates selection of a project name.

As illustrated in FIGS. 36-40, in one embodiment, a today list is provided. The today list is a calendar-like element that has both existing appointments for the day, as well as the ability to drag tasks into the white space between appointments.

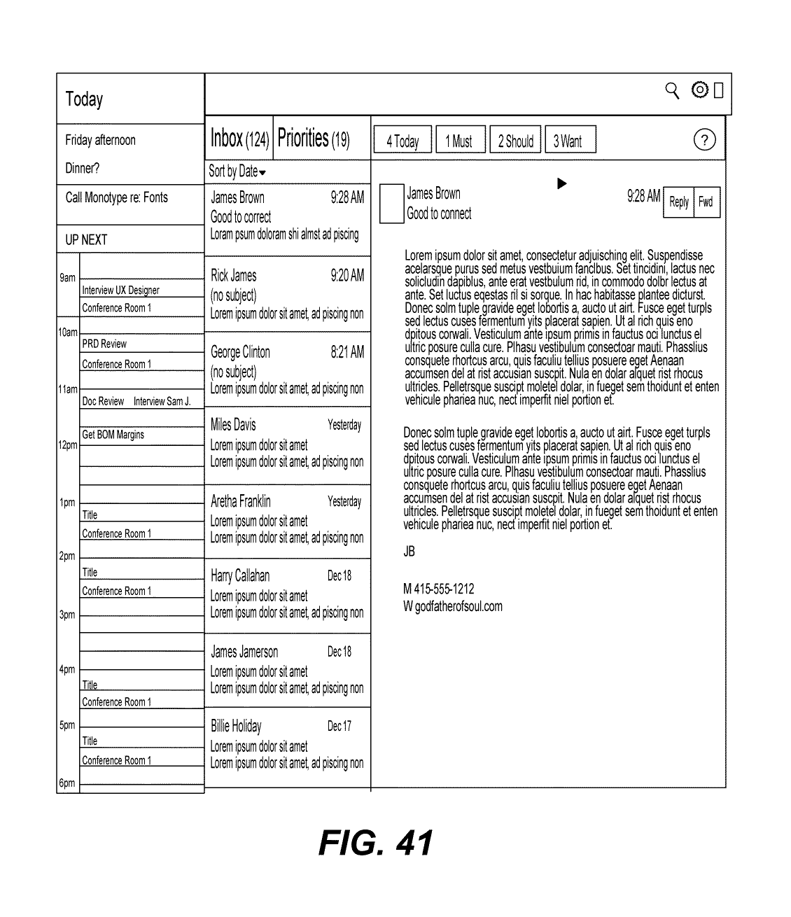

FIG. 41 shows in more detail the Today panel. In one embodiment, there are several unique aspects of the today list:

1. As the day ticks on, the location of the current time bar stays static, and the time of calendar rolls by underneath like a conveyor belt;

2. Priorities are put onto the today list, but in one implementation are not synced back to the calendar. The make it seems, to the user, like sticky notes in between appointments that can be moved around easily based on shifting priorities;

3. As the time where a priority was supposed to be completed passes, the priority moves back into the staging bucket (a separate section at the top of the today list) as a reminder the client should find time for it later in the day.

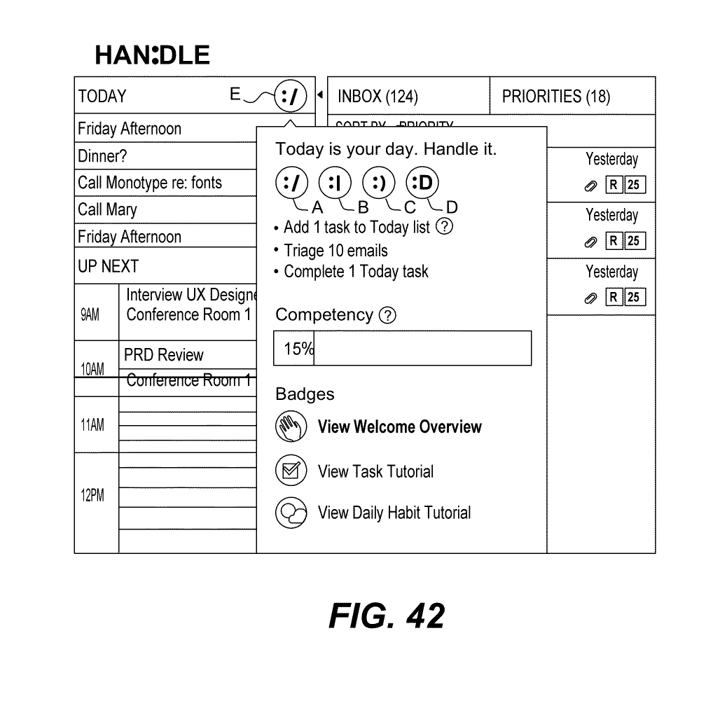

Referring to FIG. 42, in one embodiment, a “smiley game” is used as an aid to train users to use the features of the system more effectively. A little smiley face, E, is presented in the user interface to provide visual feedback on how well the user is using the system. The smiley face maps back to good behavior, providing a form of visual feedback on how well the user is utilizing the system. Additionally, suggestions may be provided on how to improve the user's game ranking to advance a happiness level. In one embodiment, the smiley face goes through four phases A, B, C, D (unsure, calm, happy, elated, corresponding to four happiness levels) and completing any of the below promotes the happiness level:
Put task(s) on the today list;
Complete the today list tasks;
Triage the inbox to a low-point that is (X) less than yesterday's low point (this means you're heading towards inbox zero bit by bit).

Thus, in the example of FIG. 42, suppose that a new user is presented with the “unsure” happy face. The list of suggestions then shows things the user can advance to a higher (happier) state in which they use the system more effectively. More generally, the game may be adapted to advance the happiness level based on the user performing one or more suggested activities. Thus, the user may be trained to effectively use different features. An analytics module monitors different metrics associated with usage patterns. That is, how does the user's use pattern compare with efficient users? The game provides the feedback and suggestions for the user to learn usage patterns that are more effective, such as usage patterns to more efficiently clean out an email box and/or process tasks.

The smiley face is one example of a training game integrated with email and task management. More generally, other visual icons or symbols could be used instead of a smiley face to represent different phases of a game ranking (e.g., quarter moon, half moon, three-quarters moon, full moon). Other forms of visual feedback may also be provided instead of icons, such as providing an indicator bar illustrating a score, such as a competency score, as a percentage.

The game mode thus monitors how well a user is using features of the system to handle messages, tasks, etc. The game then provides a score indicator (e.g., one of four happy faces) and suggestions for improving a low score and/or maintaining a high score. Thus, the game aids a user to learn how to efficiently use different features of email and task management. It will be understood that the gamification can be extended to include training for other features described in this application.

Gamification of training in not performed in conventional email and task management application. Consequently, it will be understood that in an alternate embodiment, the approach of gamification could be extended to train users of conventional email or task management tools.

In one embodiment, at least one user template is provided for outbound mail responses to make a polite refusal, such as “no thanks” or other polite refusals (e.g., “sorry, not interested”). In one implementation in the context of the command map, a single key ‘n’ brings up a special template to turn people down in a polite way. It will be understood that other polite refusals that are less firm could also be supported (e.g., “sorry not now”; “sorry, perhaps the next fiscal year” etc.) A fixed set of polite refusals may be provided. Alternately, a user may be allowed to customize the polite refusal.

In one embodiment, text expansion is built natively into the system for inputting commands for email and task management. Text expansion permits abbreviations and other shortcuts. This permits a user to input abbreviations and shortcuts into the Handlebar Toolbar. While text expander applications are used in text documents, they have not previously been natively built into an email client or a task management client.

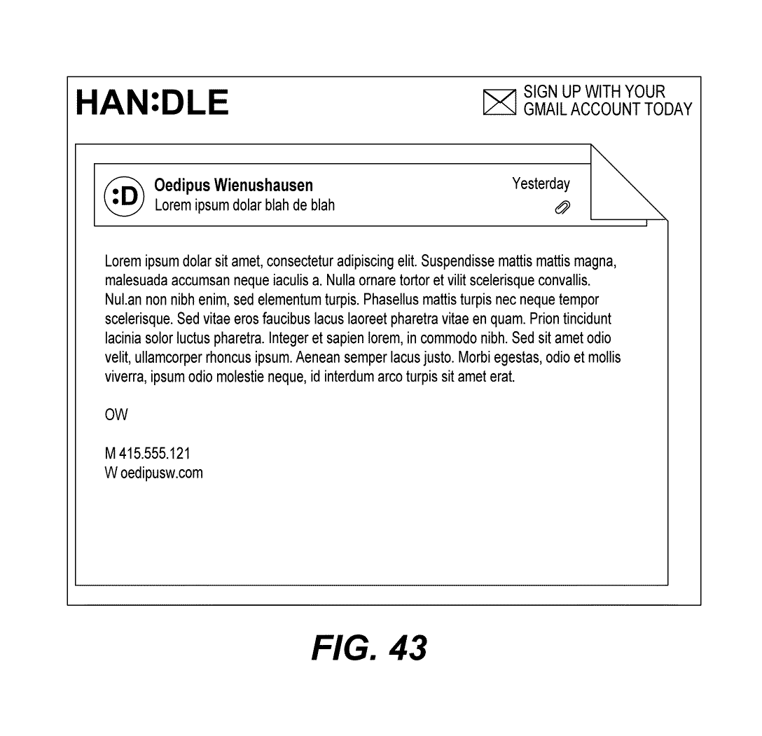

In one embodiment, a variety of additional 1-click commands are included. A 1-click push command is a shortcut command for pushing an email to a 3^{rd} party service. Examples of pushing to a third party service include pushing to the Evernote service, push to Kindle, and push to the Pocket service. A publish command is a 1-click comment to publish an email into a publicly available web page. As an illustrative example, a publish to email command can be used to publish a press release or other news announcement, which is illustrated in FIG. 43. Thus, for example, if an individual receives an email (e.g., an internal email they may use the 1-click publish command to publish the email contents (with optional editing). Alternately, a user may compose an email and use the 1-click command to publish it. That is, any email can be published by invoking the publishing command. The published email contents can be formatted into a format having a selected stationary style, such as pre-selected headers, footers, or borders. For example, a company may desire to have published emails comply with a company standard stationary format, or to comply with other pre-selected standards, such as company logos, disclaimers, or legal statements consistent with a corporate policy used in other types of documents, such as company press releases. In one embodiment, the published email can also include attachments. The published email may be published with a URL or alternately Tweeted out over a firewall. Examples of the use of publication include generating press releases and news feeds, and usages in social media.

One aspect of the system is the movement of emails around the interface.

In the interface, a user ‘moves’ the emails around as interface, from inbox to a task list, from task list to today list. This specific hierarchy of undefined work to defined work that is supposed to get done today is unique.

In one embodiment, the inbox list view shows email age in minutes, hours, days or months. This is contrast to a conventional time stamp.

In one embodiment, a collapsed email view is provided. The normal collapsed view for an email is sender and subject in virtually all mail clients. After processing an email (putting it against a task, or after it's associated with a thread), Handle will be rendering the collapsed view as the sender, and then the first few lines of the email. This is unique as a UX treatment in email clients and will make threads much more navigable.

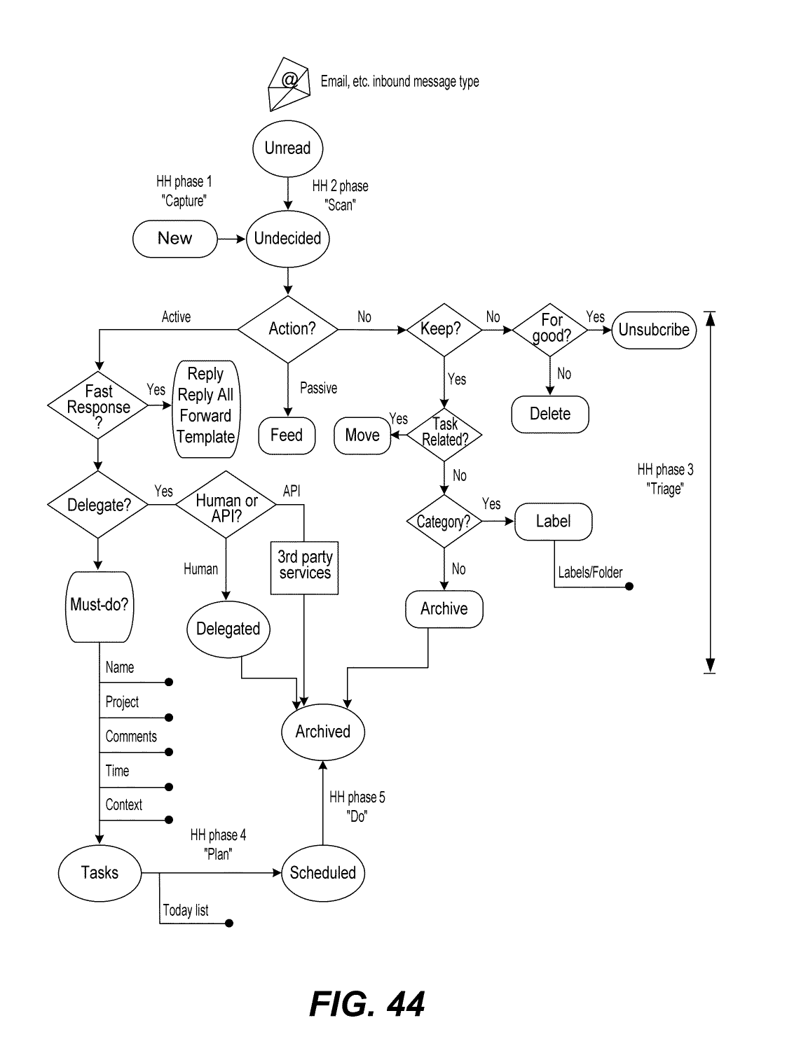

FIG. 44 illustrates a workflow diagram for an embodiment pushing an email or task to a context in accordance with an embodiment of the present invention. A context represents a resource that is needed to get a task done, or some environment where it gets done more easily. In this example, Handle Habit (HH) is modified to include additional context metadata (e.g., name, project, comments, time, and context for the must-do block of FIG. 44). One example of an application of context is the use of semantic labels; another example is supporting location specific or mobile device specific actions.

In one embodiment there is a mapping of existing generic labels from Gmail® onto semantically meaningful entities in Handle. So, for example, whereas in Gmail® or Exchange® if you had two labels, Joe and Home, they would be treated the same in that system, just emails filed under that folder. In Handle, each label can take on a semantic type. So if the Joe label is a person, then when you are meeting with Joe and Handle sees that in your calendar, all of the relevant information you tagged to Joe can be brought to the forefront. Similarly, when the phone detects you've arrived at home (via GPS) the items tagged against home can be brought to the front. So the visualization of information in the system and the systems decision of when to send notifications are based on these semantic meanings that can sometimes be sensed automatically and then used, rather than everything being treated generically like in email.

The labels and annotation of can also be considered to be a further evolution of the deliverables concept that was previously described. This evolution includes:
Collaborator+Stakeholder Groups->People Labels
Calendars->Event Labels
Folders->Labels
Deliverable Verbs/Resources->Action/Resource Labels
+Location labels
+Annotation interface
+Info architecture more familiar to users
+Semantic label associations (to PIM data)
+In-context action recommendations (Inbox Notifications)

One application is to permit a user to use their mobile device to input a command to “Send to desktop” emails and/or tasks. In one implementation, when the email/task is sent to the desktop, any necessary configuration is also performed. As one example, suppose a user has a task to complete consisting of emails, notes, URLs and documents. In a mobile device touch screen environment, the user gestures to “Send to Desktop” and, the desktop configures operating system applications (e.g., OSX apps), window sizes, and browser tabs (including Handle and the related emails). That is, it switches the Desktop computing environment to the exact environment the user needs to execute for the email/task sent to the desktop.

In one embodiment, a Handle OSX background application would be a context switcher that retains different execution modalities. In one embodiment it would also attempt to pull up all those “Send to Desktop” emails with no metadata for full triaging before the user jumps into their native email application.

One usage scenario if for users to use their mobile devices for communication and collaboration, particularly when the user is offsite, such as weekends, evenings, and vacations. This leaves document creation, web apps, and domain-specific desktop applications the primary use of desktop. This, in this type of usage scenario there is a high value for user to route their email or tasks to the appropriate platform from their mobile device.

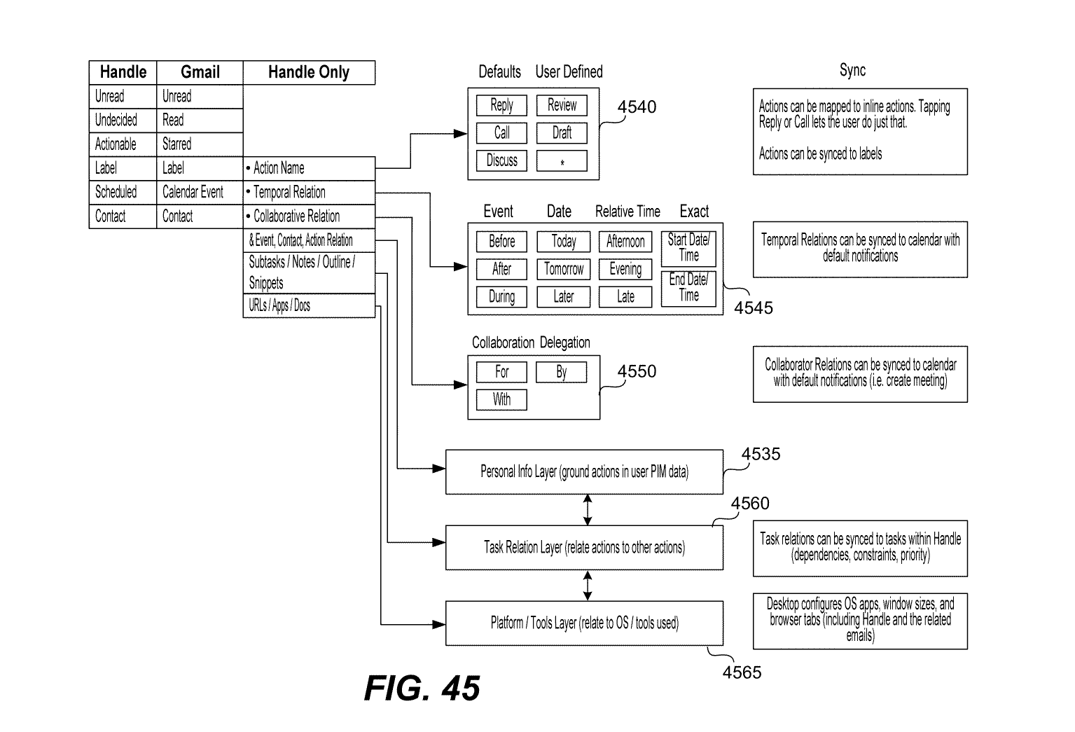

FIG. 45 illustrates aspects of user context and deliverables for optimization in accordance with an embodiment of the present invention. The system supports a set of default and user-defined action names 4540, temporal relationships 4545, collaboration relationships 4550. A personal information layer (e.g., to ground action in a personal information management (PIM) data) 4555, a task relation layer 4560 to relate actions to other actions, and a platform tools layer 4565 to related to the OS/tools used. Thus, as an illustrative example, a Task Recommendation may be selected based on User PIM Data, Task/Attention Queue, and Platform State (i.e., applications open to URLs/docs).

One application of the use of context and deliverables is in effectively using a mobile device with limited capabilities in combination with other devices having a larger screen, keyboard, or more advanced applications, such as a desktop computer. Based on the context (use of a mobile device having limited capabilities and perhaps other contextual factors), the processing is optimized for handling email and tasks. As one example, end users may desire to use a mobile device, such as a smart phone, to perform quick triage operations while performing more detailed processing on a larger screen device having an extended keyboard, such as their desktop computer.

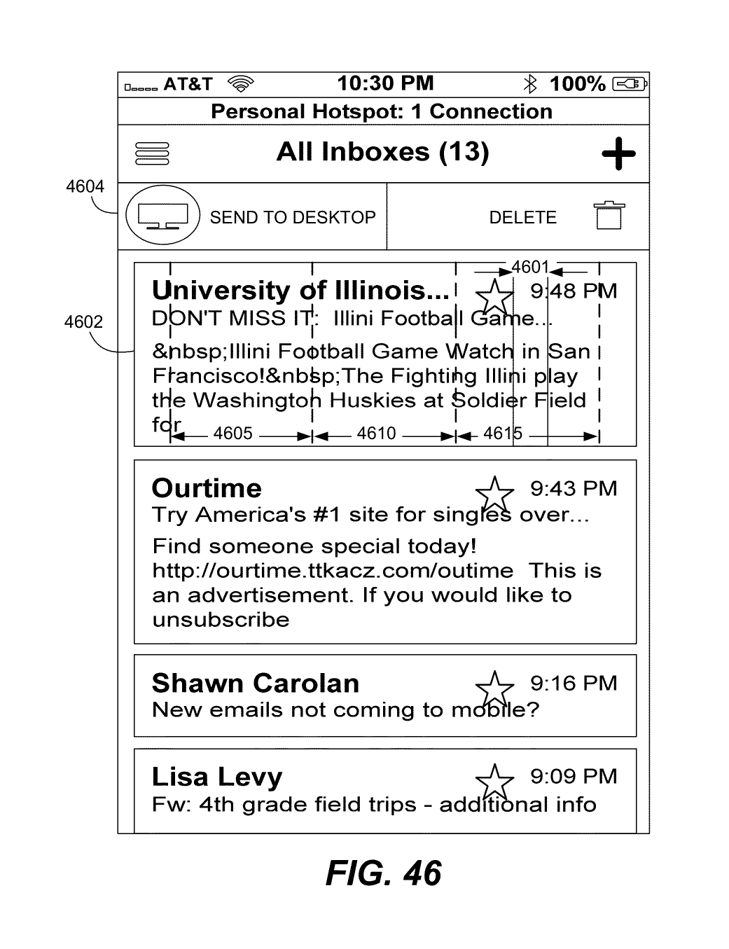

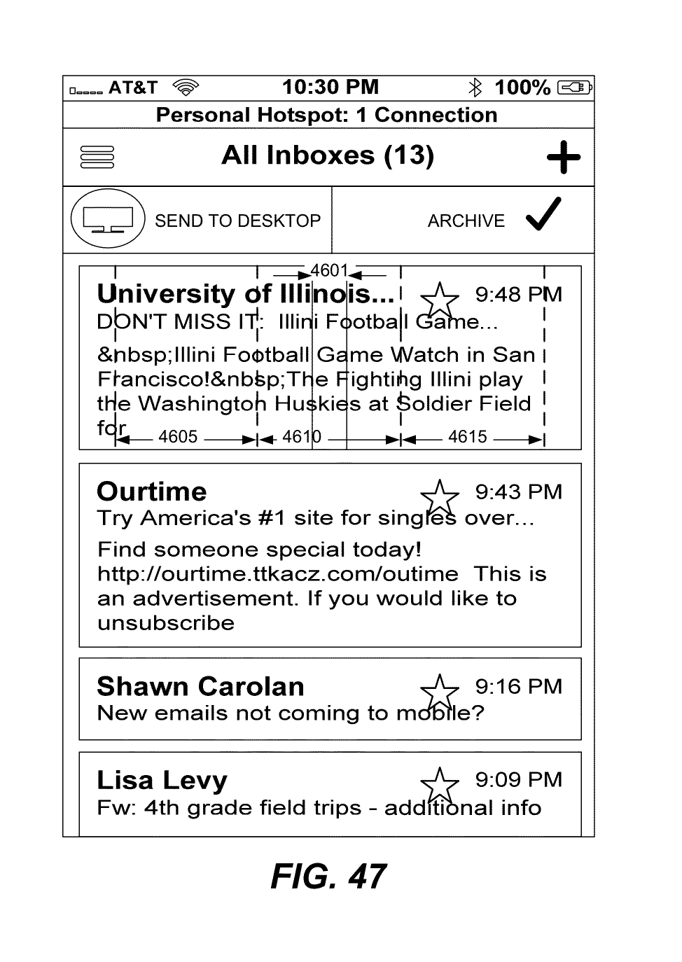

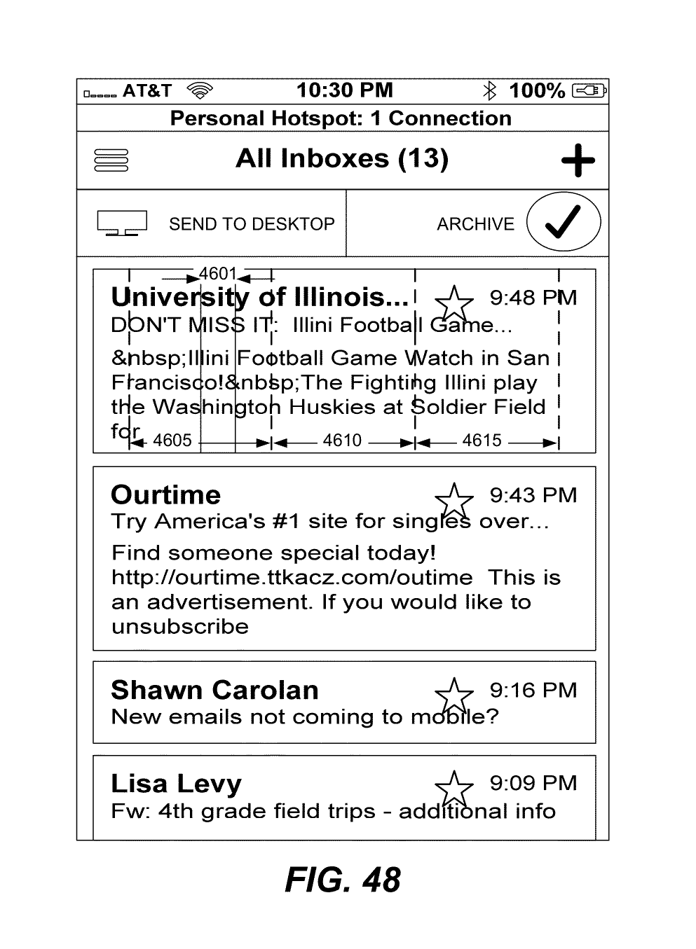

In one embodiment, the use of context (using a mobile device, particular in combination with other context attributes) supports handling email management across different user devices. FIGS. 46-48 illustrate user interface screenshots for a mobile device to perform a quick triage of incoming emails, such as triaging emails to perform deletions, archiving, and sending to a desktop computer for later processing. An email inbox on a mobile device, such as a smartphone, displays a list of emails. In one implementation, a user can select a command by selection a horizontal segment of the email, such as segments 4605, 4610, and 4615. This can be performed by touch screen commands such as sliding and tapping. For example a slide bar 4601 may be provided to indicate to the user which segment they are selecting. The user slides the slide bar horizontally across the email. A corresponding command in a command line 4604 is selected. In the example of FIG. 46, segment 4615 is selected corresponding to entry of a delete command and the delete section is highlighted. FIG. 47 illustrates the slider 4601 in segment 4610, corresponding to an archive command. FIG. 48 illustrates the slider in segment 4605, corresponding to the send to desktop command.

In the case of email triage from a mobile device, in one implementation the core triage is: (1) send to delete (FIG. 46), (2) archive (FIG. 47), or (3) send to the user's desktop computer (FIG. 48). For option 3, the sent email “disappears” from the email listing displayed on the mobile device but appears in the context of the desktop computer. An advantage of supporting efficient triage in this manner is that it supports the combined use of multiple devices. The user can use simple single-input triage commands to clear the email inbox of the mobile device while the use of context permits emails sent to the user' desktop computer to be later processed by the end user. As previously discussed, additionally the “send to desktop” command may also result, in steps to facilitate triage of the sent email on the desktop.

Other examples of the use of contexts are to send an email to a location (home work) and queuing up audio to listen to or calls to make on a commute.

Context may also be applied to tasks. In one embodiment, when user enters that context, in-application notifications would show the tasks that are now relevant to do.

### Alternate Embodiments

While examples have been provided of providing the service from a service provider, it will also be understood that one or more of the aspects described in this application could also be implemented by an individual email service provider, software provider, or provider of task management software. That is, it will be understood that individual elements of the present application have individual utility and at least some features may be integrated with conventional services such as Microsoft Exchange.

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines.

In addition, those of ordinary skill in the art will recognize that aspects of the service may be implemented, at least in part, with devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention may also be tangibly embodied as a set of computer instructions stored on a computer readable medium, such as a memory device.

What is claimed is:

1. A method of providing integrated email and task management, comprising:
providing a common user interface toolbar to receive commands to manage both email and tasks.

2. The method of claim 1, wherein the common user interface toolbar is further utilized to access third party services of the user.

3. The method of claim 1, comprising:
receiving a single character input command in the user interface toolbar; and
performing at least one of email and task management based on the single character command.

4. The method of claim 1, wherein in response to an input in the common user interface, an email is converted into a task.

5. A service providing integrated email and task management, comprising:
a user interface element to generate a user interface on a client device in communication with the service, the user interface providing:
at least one navigation view providing information on incoming emails and tasks to be processed by the user; and
a user interface toolbar to enter commands for email and task management, including at least one command to convert an email into a task.

6. The service of claim 5, where the navigation view indicates the number of incoming emails and a number of tasks in at least one task category.

7. The service of claim 5, wherein in a focus mode, an indication is provided of the number of incoming emails and the number of tasks.

8. The service of claim 5, further comprising providing a notification in the focus mode when an email has been converted into a task.

9. The service of claim 5, wherein the service further comprises a cloud assist to process emails by transferring emails with an email protocol and transfer extended metadata associated with tasks or collaborations via the cloud assist.

10. The service of claim 5, where the user interface further comprises a collaboration container in which at least one message is persistently stored and the collaboration container includes metadata to natively interact from messages within the collaboration container.

11. The service of claim 5, wherein the user interface input toolbar supports single-character commands and inline guidance.

12. The service of claim 5, wherein the user interface input toolbar receives natural language commands and support is provided to process and access third party services based on the commands.

13. The service of claim 5, further comprising third party native facilities support to permit a command entered in the user interface toolbar to be implemented according to the specific protocol variation of a third party service.

14. The service of claim 5, further comprising populating a VIP list and performing at least one of email prioritization or email display based on the VIP list.

15. The service of claim 5, further comprising prioritization of workflow for email or task management based on metadata indicative of priority.

16. The service of claim 5, further comprising generating a common thread view of emails associated with a task.

17. The service of claim 5, wherein a task generated from an email may be handed off to a delegate.

18. The service of claim 5, wherein an expected time to perform a task may be entered and associated with the task.

19. The service of claim 5, wherein an email may be selected for later processing with an associated time delay before the email is displayed for further processing.

20. The service of claim 5, wherein the service further supports a deliverable element associating collaborators and at least one stakeholder with a resource.

21. The service of claim 5 wherein the service includes a database, at least one processor, and a memory.

22. The service of claim 21, wherein the database includes task metadata, user metadata, and settings metadata.

23. The service of claim 21, wherein the service includes core logic, support for providing the service via a web server or third party communication API, and support for third party services.

24. The service of claim 21, further including support for a browser plug-in version of the user interface.

25. The service of claim 1, in which the service is context aware and in which a user may triage emails from a mobile device including options for deleting email and sending an email to the user's desktop device.
